(19) United States
(12) Patent Application Publication
(10) Pub. No.: US 2025/0358740 A1
(43) Pub. Date: Nov. 20, 2025

(54) METHOD AND APPARATUS FOR ENERGY SAVING IN WIRELESS COMMUNICATION SYSTEM

(71) Applicant: Samsung Electronics Co., Ltd., Gyeonggi-do (KR)

(72) Inventors: Junyung YI, Gyeonggi-do (KR); Younsun KIM, Gyeonggi-do (KR); Hyoungju JI, Gyeonggi-do (KR); Seunghoon CHOI, Gyeonggi-do (KR)

(21) Appl. No.: 19/205,161

(22) Filed: May 12, 2025

(30) Foreign Application Priority Data
May 16, 2024 (KR) 10-2024-0064104

(51) Int. Cl. H04W 52/02; H04W 36/08; H04W 56/00

(52) U.S. Cl. CPC H04W 52/0235; H04W 36/08; H04W 56/0015

(57) ABSTRACT

The disclosure relates to a fifth generation (5G) or sixth generation (6G) communication system for supporting a higher data transmission rate. A method performed by a terminal in a wireless communication system includes receiving, from a first cell, a wake up signal (WUS) configuration, considering a second cell as a candidate cell for cell reselection based on the WUS configuration, transmitting, to the second cell, a WUS based on the WUS configuration for requesting a system information block 1 (SIB 1) and receiving, from the second cell, the SIB1.

### CROSS-REFERENCE TO RELATED APPLICATION(S)

This application is based on and claims priority under 35 U.S.C. § 119 to Korean Patent Application No. 10-2024-0064104, filed on May 16, 2024, in the Korean Intellectual Property Office, the disclosure of which is incorporated herein by reference in its entirety.

### BACKGROUND

### 1. Field

The disclosure relates generally to operations of a terminal and a base station (BS) in a wireless communication system, and more particularly, to a method and an apparatus for energy saving in a wireless communication system.

### 2. Description of Related Art

Fifth generation (5G) mobile communication technologies define broad frequency bands such that high transmission rates and new services are possible, and can be implemented in sub 6 gigahertz (GHz) bands such as 3.5 GHz, and in above 6 GHz bands, which may be referred to as millimeter wave (mmWave) bands, including 28 GHz and 39 GHz bands. In addition, it has been considered to implement sixth generation (6G) mobile communication technologies referred to as beyond 5G systems in terahertz (THz) bands (e.g., 95 GHz to 3 THz bands) to accomplish transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

There is also ongoing standardization in air interface architecture/protocol regarding technologies such as industrial Internet of things (IoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying random access procedures for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure is to provide a communication system in which signals and channels that conventionally are always transmitted periodically, are transmitted only when necessary via an on-demand SIB1 operation of a BS, to avoid unnecessary energy consumption of a BS.

An aspect of the disclosure is to provide an on-demand SIB1 operation of a BS for energy saving of the BS and a corresponding terminal operation.

An aspect of the disclosure is to provide a communication system in which a BS may perform system information block 1 (SIB1) transmission on-demand to reduce energy consumption.

The technical subjects pursued in the disclosure may not be limited to the above-mentioned technical subjects, and other technical subjects which are not mentioned herein may be clearly understood from the following description by those skilled in the art to which the disclosure pertains.

In accordance with an aspect of the disclosure, a base station may perform system information block 1 (SIB1) transmission on-demand in order to reduce energy consumption. In this case, the base station may receive a wake-up signal (WUS) from a terminal in order to transmit SIB1 on-demand. The base station may transmit SIB1 when the WUS for requesting SIB1 is received from the terminal.

In accordance with an aspect of the disclosure, the terminal may determine whether to perform an on-demand operation of a corresponding cell after receiving a synchronization signal block (SSB) or receiving an SSB and higher-layer signaling. Afterward, in a multi-cell scenario, configuration information for wake-up-signal transmission and some information of SIB1 may be configured via a neighboring cell.

In accordance with an aspect of the disclosure, in a multi-cell scenario, configuration information for wake-up-signal transmission and some information of SIB1 may be configured via a neighboring cell.

In accordance with an aspect of the disclosure, for the on-demand SIB1 transmission operation, WUS configuration including time/frequency resource configuration information for WUS transmission and SIB1 information including cell access information may be configured based on higher-layer signaling or a pre-configured/pre-fixed method. For example, the configuration may be configured via a neighboring cell. According to various embodiments of the disclosure, a method and an apparatus for operating a terminal/base station according to each configuration may be provided.

In accordance with an aspect of the disclosure, the disclosure may provide a configuration method based on higher-layer signaling (e.g., RRC signaling) or a pre-configured/pre-fixed method for applying an on-demand SIB1 operation. According to various embodiments of the disclosure, provided may be a method for activating and deactivating, based on the configuration information, on-demand SIB1 transmission via uplink (UL) signal/channel transmission, etc.

In accordance with an aspect of the disclosure, a method performed by a terminal in a wireless communication system includes receiving, from a first cell, a wake up signal (WUS) configuration, considering a second cell as a candidate cell for cell reselection based on the WUS configuration, transmitting, to the second cell, a WUS based on the WUS configuration for requesting a system information block 1 (SIB 1) and receiving, from the second cell, the SIB1.

In accordance with an aspect of the disclosure, a method performed by a base station (BS) in a wireless communication system includes transmitting, on a second cell, a synchronization signal block (SSB), receiving, on the second cell from a terminal that receives a wake up signal (WUS) configuration from a first cell, a WUS for requesting system information block 1 (SIB 1) of the second cell, and transmitting, on the second cell, the SIB 1 based on the WUS, wherein, in case that the second cell is an on-demand SIB1 cell, a subcarrier offset of the SSB is greater than a predetermined value, and wherein the subcarrier offset of the SSB is included in a master information block (MIB) of the second cell. In accordance with an aspect of the disclosure, a terminal in a wireless communication system includes a transceiver and at least one processor coupled to the transceiver and configured to receive, from a first cell, a wake up signal (WUS) configuration, to consider a second cell as a candidate cell for cell reselection based on the WUS configuration, to transmit, to the second cell, a WUS based on the WUS configuration for requesting system information block 1 (SIB 1), and to receive, from the second cell, the SIB1.

In accordance with an aspect of the disclosure, a BS in a wireless communication system includes a transceiver and at least one processor coupled to the transceiver and configured to transmit, on a second cell, SSB, to receive, on the second cell from a terminal for which received WUS configuration from a first cell, WUS for requesting an SIB 1 of the second cell, and to transmit, on the second cell, the SIB 1 based on the WUS, wherein, in case that the second cell is an on-demand SIB1 cell, a subcarrier offset of the SSB is greater than a predetermined value, and wherein the subcarrier offset of the SSB is included in an MIB of the second cell.

The aforementioned various embodiments of the disclosure are merely some of preferred embodiments of the disclosure, and various embodiments reflecting technical features of the various embodiments of the disclosure may be derived and understood by those having ordinary skill in the art based on the detailed descriptions to be described below.

According to an embodiment of the disclosure, in a communication system, signals and channels (e.g., SSB or SIB1), which are always transmitted periodically in the past, can be transmitted only when necessary via an on-demand SIB1 operation of a base station, so that unnecessary energy consumption of a base station can be reduced.

According to an embodiment of the disclosure, an on-demand SIB1 operation of a base station for energy saving of the base station and a corresponding terminal operation can be provided.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a time-frequency domain as a radio resource region in a wireless communication system according to an embodiment;

FIG. 2 illustrates a slot structure in a wireless communication system according to an embodiment;

FIG. 3 illustrates a beam sweeping operation and a time domain mapping structure of a synchronization signal according to an embodiment;

FIG. 4 illustrates an SSB considered in a wireless communication system according to an embodiment;

FIG. 5 illustrates various transmission cases of an SSB in a frequency band less than 6 GHz considered in a wireless communication system according to an embodiment;

FIG. 6 illustrates transmission cases of an SSB in a frequency band of 6 GHz or higher considered in a wireless communication system according to an embodiment;

FIG. 7 illustrates transmission cases of an SSB according to subcarrier spacing within 5 ms in a wireless communication system according to an embodiment;

FIG. 8 illustrates demodulation reference signal (DMRS) patterns (type 1 and type 2) used for communication between a BS and a UE in a wireless communication system according to an embodiment;

FIG. 9 illustrates channel estimation using a DMRS received from one physical UL shared channel (PUSCH) in a time band of a wireless communication system according to an embodiment;

FIG. 10 illustrates a method of reconfiguring SSB transmission via dynamic signaling in a wireless communication system according to an embodiment;

FIG. 11 illustrates a method of reconfiguring a BWP and a bandwidth (BW) via dynamic signaling in a wireless communication system according to an embodiment;

FIG. 12 illustrates a method of reconfiguring discontinuous reception (DRX) via dynamic signaling in a wireless communication system according to an embodiment;

FIG. 13 illustrates an example for explaining a discontinuous transmission (DTX) method for BS energy saving according to an embodiment;

FIG. 14 illustrates an operation of a BS according to a gNB WUS according to an embodiment;

FIG. 15 illustrates an antenna adaptation method of a BS for energy saving in a wireless communication system according to an embodiment;

FIG. 16 illustrates an on-demand SIB1 operation of a BS and a UE considering multiple cells according to an embodiment;

FIG. 17 illustrates an on-demand SIB1 operation of a BS and a UE considering a single cell according to an embodiment;

FIG. 18 illustrates an on-demand SIB1 operation considering multiple cells according to an embodiment;

FIG. 19 illustrates an on-demand SIB1 operation considering multiple cells according to an embodiment;

FIG. 20 illustrates an on-demand SIB1 operation considering multiple cells according to an embodiment;

FIG. 21 is a method of a UE for applying an energy saving method in the wireless communication system according to an embodiment;

FIG. 22 is a method of a BS for applying an energy saving method in the wireless communication system according to an embodiment;

FIG. 23 is a block diagram of a UE according to an embodiment; and

FIG. 24 is a block diagram of a BS according to an embodiment.

### DETAILED DESCRIPTION

The following description with reference to the accompanying drawings is provided to assist in a comprehensive understanding of embodiments of the disclosure. It includes various specific details to assist in that understanding but these are to be regarded as merely examples. Accordingly, those of ordinary skill in the art will recognize that various changes and modifications of the embodiments described herein can be made without departing from the scope and spirit of the disclosure. Description of well-known functions and constructions may be omitted for the sake of clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for limiting the disclosure.

Herein, singular forms “a,” “an,” and “the” include plural referents unless the context clearly dictates otherwise. Thus, for example, reference to “a component surface” includes reference to one or more of such surfaces.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

In the accompanying drawings, some elements may be exaggerated, omitted, or schematically illustrated and the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the term “unit” refers to a software element or a hardware element, such as a field programmable gate array (FPGA) or an application specific integrated circuit (ASIC), which performs a predetermined function. However, the “unit” does not always have a meaning limited to software or hardware. The unit may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units or may be implemented to reproduce one or more central processing units (CPUs) within a device or a security multimedia card.

The method and apparatus proposed in the embodiments of the present disclosure below are not limited to each embodiment, but may also be utilized as a combined embodiment of one or more embodiments in the disclosure. Accordingly, the embodiments of the present disclosure may be applied through some modifications within a range that does not significantly deviate from the scope of the present disclosure as judged by a person having ordinary technical knowledge.

In the following description, a BS (BS) is an entity that allocates resources to terminals, and may be at least one of a gNode B, an eNode B, a Node B, a wireless access unit, a BS controller, and a node on a network. A terminal may include a UE, an MS, a cellular phone, a smartphone, a computer, or a multimedia system capable of performing a communication function. In the disclosure, a downlink (DL) refers to a radio link via which a BS transmits a signal to a terminal, and an uplink (UL) refers to a radio link via which a terminal transmits a signal to a BS.

Herein, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may be applied to other communication systems through some modifications without significantly departing from the scope of the disclosure.

A wireless communication system is advancing to a broadband wireless communication system for providing high-speed and high-quality packet data services using communication standards, such as high-speed packet access (HSPA) of 3GPP, long term evolution-advanced (LTE-A), LTE-Pro, high-rate packet data (HRPD) of third generation partnership project 2 (3GPP2), ultra-mobile broadband (UMB), institute of electrical and electronics engineers (IEEE) 802.17e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL), which refers to a radio link via which a UE or a mobile station (MS) transmits data or control signals to a BS (BS, eNode B, or gNode B). The DL refers to a radio link via which the BS transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include eMBB, mMTC, URLLC, and the like.

eMBB aims at providing a data rate higher than that supported by existing LTE, LTE-A, or LTE-Pro. For example, in the 5G communication system, eMBB must provide a peak data rate of 20 gigabits per second (Gbps) in the DL, a peak data rate of 10 Gbps in the UL for a single BS, and an increased user-perceived data rate to the UE, as well as the maximum data rate. To satisfy such requirements, transmission/reception technologies including a further enhanced MIMO transmission technique are required to be improved. In addition, the data rate required for the 5G communication system may be obtained using a frequency bandwidth more than 20 megahertz (MHz) in a frequency band of 3 to 6 GHz or 6 GHz or more, instead of transmitting signals using a transmission bandwidth up to 20 MHz in a band of 2 GHz used in LTE.

The mMTC is being considered to support application services such as the IoT in the 5G communication system and has requirements, such as support of connection of many UEs in a cell, enhancement coverage of UEs, improved battery time, and reduced UE cost, to effectively provide the IoT. Since the IoT provides communication functions while being provided to various sensors and various devices, it must support many UEs (e.g., 1,000,000 UEs/squared kilometers (km²)) in a cell. In addition, the UEs supporting mMTC may require wider coverage than those of other services provided by the 5G communication system because the UEs are likely to be located in a shadowed area, such as a basement of a building, which is not covered by the cell due to the nature of the service. The UE supporting mMTC must be configured to be inexpensive and to have a very long battery life-time such as 10 to 15 years since it is difficult to frequently replace the battery of the UE.

URLLC is a cellular-based mission-critical wireless communication service. For example, URLLC may be considered as services used for remote control for robots or machinery, industrial automation, unmanned aerial vehicles, remote health care, or emergency alert. Thus, URLLC must provide communication with ultra-low latency and ultra-high reliability. For example, a service supporting URLLC must satisfy an air interface latency of less than 0.5 milliseconds (ms), and may also require a packet error rate of 10-5 or less. Therefore, for the services supporting URLLC, a 5G system must provide a transmit time interval (TTI) shorter than those of other services, and must also assign many resources in a frequency band to secure reliability of a communication link.

The three services in the 5G communication system (hereinafter may be interchangeably used with “5G system”), that is, eMBB, URLLC, and mMTC, may be multiplexed and transmitted in a single system. In this case, different transmission/reception techniques and transmission/reception parameters may be used between services to satisfy different requirements of the respective services.

Hereinafter, a time-frequency domain resource and a frame structure of a 5G system will be described in more detail with reference to the accompanying drawings. Hereinafter, a configuration of a 5G system will be described as a wireless communication to which the disclosure is applied for the sake of descriptive convenience, but the embodiments of the disclosure may also be applied in the same or similar manner to 5G or higher systems or other communication systems to which the disclosure is applicable.

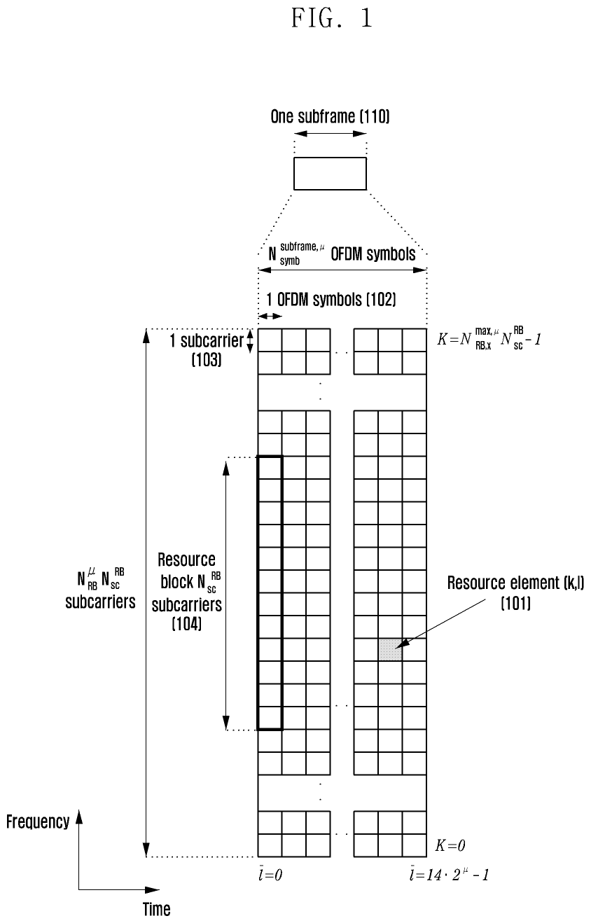

FIG. 1 illustrates a time-frequency domain as a radio resource region in a wireless communication system according to an embodiment.

Referring to FIG. 1, the horizontal axis denotes a time domain, and the vertical axis denotes a frequency domain. The basic unit of resources in the time-frequency domain is a resource element (RE) 101, which may be defined as one OFDM symbol (or discrete Fourier transform spread OFDM (DFT-s-OFDM) symbol) 102 on the time axis and one subcarrier 103 on the frequency axis. In the frequency domain,

$${N}_{SC}^{RB}$$

(e.g., 12) consecutive KES representing the number of subcarriers per resource block (RB) may constitute one RB 104. In the time domain,

$${N}_{symb}^{subframe , μ}$$

consecutive OFDM symbols representing the number of symbols per subframe according to subcarrier spacing configuration values u may constitute one subframe 110.

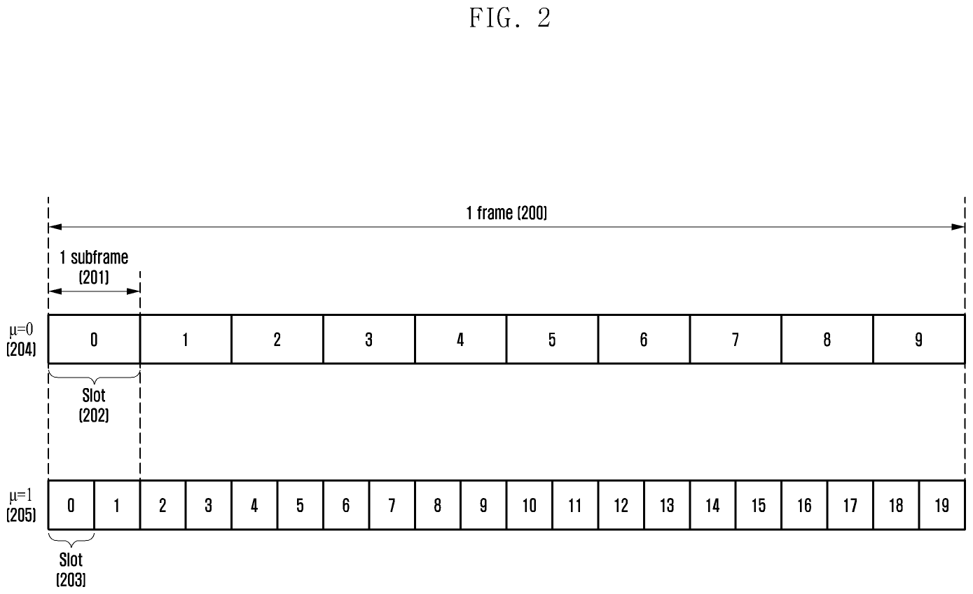

FIG. 2 illustrates a slot structure considered in a wireless communication system according to an embodiment.

Referring to FIG. 2, a slot structure including a frame 200, a subframe 201, and a slot 202 or 203 is illustrated. One frame 200 may be defined as 10 ms. One subframe 201 may be defined as 1 ms, and thus one frame 200 may include a total of ten subframes. One slot 202 or 203 may be defined as 14 OFDM symbols (that is, the number of symbols per one slot

$${N}_{symb}^{slot} = 14 ) .$$

One subframe 201 may include one or multiple slots 202 and 203, and the number of slots 202 and 203 per one subframe 201 may vary depending on configuration values u for the subcarrier spacing (SCS) 204 or 205.

The slot structure is illustrated for when the subcarrier spacing configuration value is μ=0 (204), and when μ=1 (205). In μ=0 (204), one subframe 201 may include one slot 202, and in μ=1 (205), one subframe 201 may include two slots 203. That is, the number of slots per one subframe

$${N}_{slot}^{subframe , μ}$$

may differ depending on the subcarrier spacing configuration value μ, and the number of slots per one frame

$${N}_{slot}^{frame , μ}$$

may differ accordingly.

$${N}_{slot}^{subframe , μ} and {N}_{slot}^{frame , μ}$$

may be defined according to each subcarrier spacing configuration μ as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

In the 5G wireless communication system, an SSB (or SS/PBCH block) for initial access of a UE may be transmitted, and the SSB may include a primary synchronization signal (PSS), a secondary synchronization signal (SSS), and a physical broadcast channel (PBCH).

During an initial access operation of a UE accessing a system, the UE may first acquire DL time and frequency domain synchronization from a synchronization signal via a cell search and may acquire a cell ID. The synchronization signal may include a PSS and an SSS. In addition, the UE may receive, from a BS, a PBCH for transmitting of an MIB so as to acquire a basic parameter value and system information related to transmission and reception, such as a system bandwidth or related control information. Based on this information, the UE may perform decoding on a physical DL control channel (PDCCH) and a physical DL shared channel (PDSCH) so as to acquire an SIB. Then, the UE may exchange UE identification-related information with the BS based on a random-access operation, and may initially access a network based on registration and authentication operations. Additionally, the UE may receive an SIB transmitted by the BS to acquire cell-common transmission and reception-related control information. The cell-common transmission and reception-related control information may include random-access-related control information, paging-related control information, common control information for various physical channels, etc.

A synchronization signal is a signal that serves as a reference for a cell search, and for each frequency band, a subcarrier spacing may be applied adaptively to a channel environment, such as phase noise. For a data channel or a control channel, to support various services as described above, a subcarrier spacing may be applied differently depending on a service type.

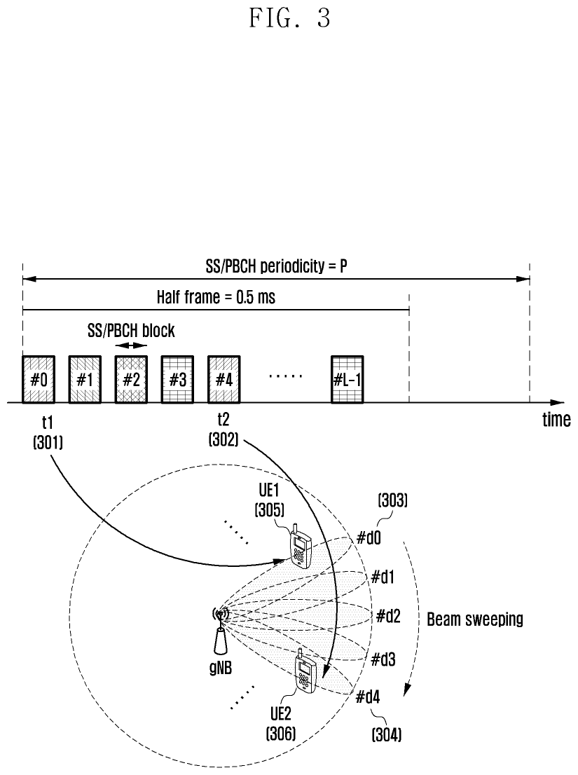

FIG. 3 illustrates a beam sweeping operation and a time domain mapping structure of a synchronization signal according to an embodiment.

For description purposes, the following elements may be defined.

A PSS serves as a reference for DL time/frequency synchronization, and provides a part of cell ID information.

An SSS serves as a reference for DL time/frequency synchronization, and provides the other part of the cell ID information. Additionally, the SSS may serve as a reference signal for PBCH demodulation of a PBCH.

A PBCH provides an MIB which is mandatory system information required for transmission and reception of a data channel and a control channel of a UE. The mandatory system information may include search space-related control information indicating radio resource mapping information of a control channel, scheduling control information for a separate data channel for transmission of system information, a system frame number (SFN) which is a frame unit index that serves as a timing reference, and other information.

A synchronization signal/PBCH block (SS/PBCH block or SSB) is configured by N OFDM symbols and includes a combination of a PSS, an SSS, a PBCH, and the like. For a system to which a beam sweeping technology is applied, an SS/PBCH block is a minimum unit to which beam sweeping is applied. In the 5G system, N=4 may be satisfied. A BS may transmit up to a maximum of L SS/PBCH blocks, and the L SS/PBCH blocks are mapped within a half frame (0.5 ms). In addition, the L SS/PBCH blocks are periodically repeated at predetermined periods P. The BS may inform a UE of period P via signaling. If there is no separate signaling of period P, the UE may apply a previously agreed default value.

Referring to FIG. 3, beam sweeping may be applied in units of SS/PBCH blocks over time. UE 1 305 receives an SS/PBCH block by means of a beam emitted in direction #d0 303 by beamforming applied to SS/PBCH block #0 at time point t1 301. In addition, UE 2 306 receives an SS/PBCH block by means of a beam emitted in direction #d4 304 by beamforming applied to SS/PBCH block #4 at time point t2 302. The UE may acquire, from the BS, an optimal synchronization signal via a beam emitted in the direction where the UE is located. For example, it may be difficult for UE 1 305 to acquire time/frequency synchronization and mandatory system information from the SS/PBCH block through the beam emitted in direction #d4 far away from the location of UE 1.

In addition to the initial access procedure, for determining whether the radio link quality of a current cell is maintained at a certain level or higher, the UE may also receive the SS/PBCH block. Furthermore, during a handover procedure in which the UE moves access from the current cell to an adjacent cell, the UE may receive an SS/PBCH block of the adjacent cell to determine the radio link quality of the adjacent cell and acquire time/frequency synchronization with the adjacent cell.

A synchronization signal serves as a reference for a cell search, and may be transmitted by applying of a subcarrier spacing appropriate for a channel environment (e.g., phase noise) for each frequency band. A 5G BS may transmit multiple SSBs according to the number of analog beams to be operated. For example, a PSS and an SSS may be mapped and transmitted over 12 RBs, and a PBCH may be mapped and transmitted over 24 RBs.

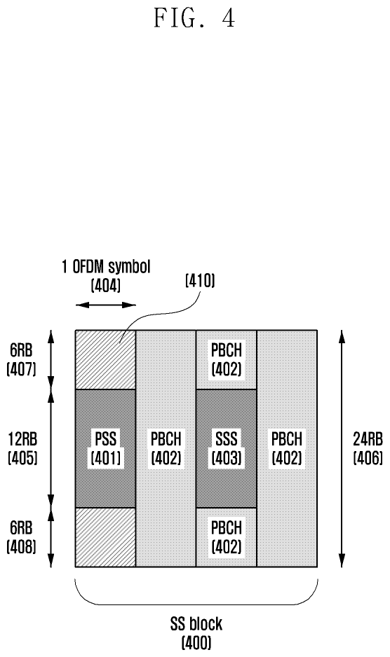

FIG. 4 illustrates an SSB considered in a wireless communication system according to an embodiment.

Referring to FIG. 4, the SSB 400 may include a PSS 401, an SSS 403, and a PBCH 402.

The SSB 400 may be mapped to four OFDM symbols 404 on the time axis. The PSS 401 and SSS 403 may be transmitted in 12 RBs 405 on the frequency axis, and in the first and third OFDM symbols, respectively, on the time axis. In the 5G system, for example, a total of 1008 different cell IDs may be defined. Depending on a physical layer cell ID (physical cell ID (PCI)) of a cell, the PSS 401 may have 3 different values, and the SSS 403 may have 336 different values. Based on detection of the PSS 401 and SSS 403, the UE may obtain one of the (336×3=)1008 cell IDs, based on a combination thereof, as expressed by Equation (1) below.

$${N}_{ID}^{cell} = 3 {N}_{ID}^{( 1 )} + {N}_{ID}^{( 2 )} \qquad ( 1 )$$

In Equation (1),

$${N}_{ID}^{( 1 )}$$

may be estimated from the SSS 403 and may have a value of 0 to 335.

$${N}_{ID}^{( 2 )}$$

may estimate an

$${N}_{ID}^{( c e l l )}$$

value as the cell ID by means of a combination of

$${N}_{ID}^{( 1 )} and {N}_{ID}^{( 2 )} .$$

In 24 RBs 406 on the frequency axis and in a second or a fourth OFDM symbol of the SSB on the time axis, the PBCH 402 may be transmitted in resources including 6 RBs 407 and 408 on both sides, excluding 12 RBs 405 while the SSS 403 is being transmitted. The PBCH 402 may include a PBCH payload and a PBCH DMRS, and various system information referred to as an MIB may be transmitted in the PBCH payload. For example, the MIB includes information as in Table 2 below.

TABLE 2

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | , |
| cellBarred | ENUMERATED {barred, notBarred}, |
| intraFreqReselection | ENUMERATED {allowed, notAllowed}, |
| spare | BIT STRING (SIZE (1)) |

}

SSB information: An offset of the frequency domain of the SSB may be indicated based on 4-bit ssb-SubcarrierOffset in a MIB. An index of the SSB including the PBCH may be obtained indirectly based on decoding of the PBCH DMRS and the PBCH. In a frequency band less than 6 GHZ, 3 bits acquired based on decoding of the PBCH DMRS may indicate the SSB index, and in a frequency band of 6 GHz or higher, a total of 6 bits, which includes 3 bits acquired based on decoding of the PBCH DMRS and 3 bits which are included in the PBCH payload and acquired from PBCH decoding, may indicate the SSB index including the PBCH.

PDCCH configuration information: A subcarrier spacing of a common DL control channel may be indicated based on 1 bit (subCarrierSpacingCommon) in a MIB, and time-frequency resource configuration information of a control resource set (CORESET) and a search space may be indicated based on 8 bits (pdcch-ConfigSIB1).

SFN: In a MIB, 6 bits (systemFrameNumber) may be used to indicate a part of an SFN. Least significant bit (LSB) 4 bits of the SFN may be included in the PBCH payload and indirectly acquired by the terminal based on PBCH decoding.

Timing information in a radio frame: Timing information is 1 bit (half frame) which is included in the aforementioned SSB index and PBCH payload, and acquired based on PBCH decoding, and the UE may indirectly identify whether the SSB has been transmitted in a first or second half frame of a radio frame.

The transmission bandwidth (12 RBs 405) for the PSS 401 and the SSS 403 is different from the transmission bandwidth (24 RBs 406) for the PBCH 402, and thus, in a first OFDM symbol in which the PSS 401 is transmitted within the PBCH 402 transmission bandwidth, there exist 6 RBs 407 and 6 RBs 408 on both sides excluding 12 RBs while the PSS 401 is being transmitted, and the area may be used for transmitting another signal or may be empty.

SSBs may be transmitted using the same analog beam. For example, the PSS 401, the SSS 403, and the PBCH 402 may be all transmitted via the same beam. Since analog beams cannot be applied differently on the frequency axis, the same analog beam may be applied to all frequency-axis RBs within a specific OFDM symbol to which a specific analog beam is applied. For example, 4 OFDM symbols in which the PSS 401, the SSS 403, and the PBCH 402 are transmitted may be all transmitted by means of the same analog beam.

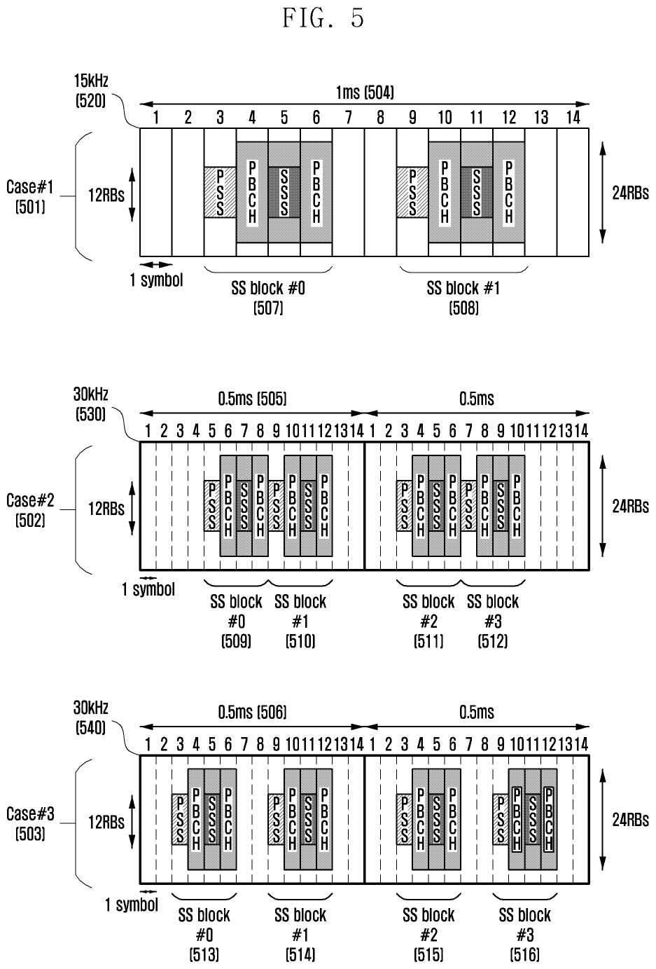

FIG. 5 illustrates various transmission cases of an SSB in a frequency band below 6 GHz considered in a wireless communication system according to an embodiment.

Referring to FIG. 5, in the 5G communication system, an SCS 520 of 15 kHz and an SCS 530 or 540 of 30 kHz may be used for SSB transmission in a frequency band of less than or equal to 6 GHz (or frequency range 1 (FR1), e.g., a frequency band of 410 MHz to 7,125 MHz). There may be one transmission case (e.g., case #1 501) for an SSB in the subcarrier spacing 520 of 15 kHz, and there may be two transmission cases (e.g., case #2 502 and case #3 503) for an SSB in the subcarrier spacing 530 or 540 of 30 kHz.

In case #1 501 with the subcarrier spacing 520 of 15 kHz, a maximum of 2 SSBs may be transmitted in 1 ms 504 (or corresponding to a length of one slot when one slot includes 14 OFDM symbols). In FIG. 5, SSB #0 507 and SSB #1 508 are illustrated. For example, SSB #0 507 may be mapped to 4 consecutive symbols starting from a third OFDM symbol, and SSB #1 508 may be mapped to 4 consecutive symbols starting from a ninth OFDM symbol. Different analog beams may be applied to SSB #0 507 and SSB #1 508. In addition, the same beam may be applied to all of the third to sixth OFDM symbols to which SSB #0 507 is mapped, and the same beam may be applied to all of the ninth to 12th OFDM symbols to which SSB #1 508 is mapped. With regard to beams to be used for seventh, eighth, 13th, and 14th OFDM symbols to which no SSB is mapped, an analog beam may be freely determined at the discretion of a BS.

In case #2 502 with the subcarrier spacing 530 of 30 kHz, a maximum of 2 SSBs may be transmitted in 0.5 ms 505 (or corresponding to a length of one slot when one slot includes 14 OFDM symbols), and accordingly, a maximum of 4 SSBs may be transmitted in 1 ms (or corresponding to a length of two slots when one slot includes 14 OFDM symbols). In FIG. 5, a case where SSB #0 509, SSB #1 510, SSB #2 511, and SSB #3 512 are transmitted in 1 ms (i.e., two slots) is illustrated. SSB #0 509 and SSB #1 510 may be mapped starting from a 5th OFDM symbol and a 9th OFDM symbol of a first slot, respectively, and SSB #2 511 and SSB #3 512 may be mapped starting from a 3rd OFDM symbol and a 7th OFDM symbol of a second slot, respectively.

Different analog beams may be applied to SSB #0 509, SSB #1 510, SSB #2 511, and SSB #3 512, respectively. In addition, the same analog beam may be applied to all of fifth to eighth OFDM symbols of a first slot in which SSB #0 509 is transmitted, ninth to 12th OFDM symbols of the first slot in which SSB #1 510 is transmitted, third to sixth symbols of a second slot in which SSB #2 511 is transmitted, and seventh to 10th symbols of the second slot in which SSB #3 512 is transmitted. With regard to beams to be used for OFDM symbols to which no SSB is mapped, analog beams may be freely determined at the discretion of a BS.

In case #3 503 with the subcarrier spacing 540 of 30 kHz, a maximum of 2 SSBs may be transmitted in 0.5 ms 506 (or corresponding to a length of one slot when one slot includes 14 OFDM symbols), and accordingly, a maximum of 4 SSBs may be transmitted in Ims (or corresponding to a length of two slots when one slot includes 14 OFDM symbols). In FIG. 5, transmission of SSB #0 513, SSB #1 514, SSB #2 515, and SSB #3 516 in 1 ms (i.e., two slots) is illustrated. SSB #0 513 and SSB #1 514 may be mapped starting from a third OFDM symbol and a ninth OFDM symbol of a first slot, respectively, and SSB #2 515 and SSB #3 516 may be mapped starting from a third OFDM symbol and a ninth OFDM symbol of a second slot, respectively.

Different analog beams may be used for SSB #0 513, SSB #1 514, SSB #2 515, and SSB #3 516, respectively. The same analog beam may be used for all 4 OFDM symbols in which respective SSBs are transmitted, and in OFDM symbols to which no SSB is mapped, beams to be used may be freely determined at the discretion of a BS.

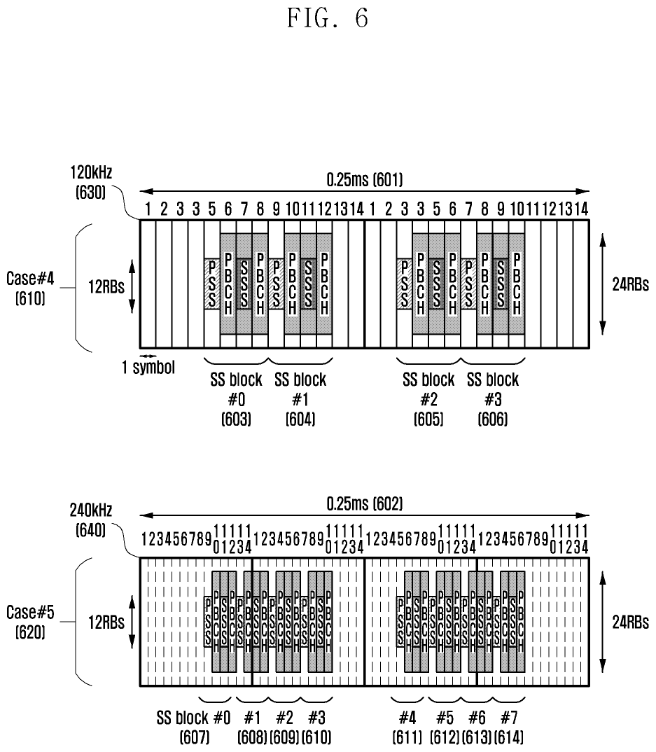

FIG. 6 illustrates transmission cases of an SSB in a frequency band of greater than or equal to 6 GHz considered in a wireless communication system according to an embodiment.

Referring to FIG. 6, in a frequency band of greater than or equal to 6 GHz (or FR2, e.g., 24250 MHz to 52000 MHz), a subcarrier spacing 630 of 120 kHz as shown in case #4 610 and a subcarrier spacing 640 of 240 kHz as shown in case #5 620 may be used for SSB transmission.

In case #4 610 with the subcarrier spacing 630 of 120 kHz, a maximum of 4 SSBs may be transmitted in 0.25 ms of time 601 (or corresponding to a length of two slots when one slot includes 14 OFDM symbols). In FIG. 6, a case where SSB #0 603, SSB #1 604, SSB #2 605, and SSB #3 606 are transmitted in 0.25 ms (i.e., two slots) is illustrated. SSB #0 603 and SSB #1 604 may be respectively mapped to 4 consecutive symbols starting from a fifth OFDM symbol and to 4 consecutive symbols starting from a ninth OFDM symbol of a first slot, and SSB #2 605 and SSB #3 606 may be respectively mapped to 4 consecutive symbols starting from a third OFDM symbol and to 4 consecutive symbols starting from a seventh OFDM symbol of a second slot.

Different analog beams may be used for SSB #0 603, SSB #1 604, SSB #2 605, and SSB #3 606, respectively. In addition, the same analog beam may be used for all 4 OFDM symbols in which respective SSBs are transmitted, and in OFDM symbols to which no SSB is mapped, beams to be used may be freely determined at the discretion of a BS.

In case #5 620 with the subcarrier spacing 640 of 240 kHz, a maximum of 8 SSBs may be transmitted in 0.25 ms 602 (or corresponding to a length of 4 slots when one slot includes 14 OFDM symbols). In FIG. 6, a case where SSB #0 607, SSB #1 608, SSB #2 609, SSB #3 610, SSB #4 611, SSB #5 612, SSB #6 613, and SSB #7 614 are transmitted in 0.25 ms (i.e., 4 slots) is illustrated.

SSB #0 607 and SSB #1 608 may be respectively mapped to 4 consecutive symbols starting from a ninth OFDM symbol and to 4 consecutive symbols starting from a 13th OFDM symbol of a first slot, SSB #2 609 and SSB #3 610 maybe respectively mapped to 4 consecutive symbols starting from a third OFDM symbol and to 4 consecutive symbols starting from a seventh OFDM symbol of a second slot, SSB #4 611, SSB #5 612, and SSB #6 613 may be respectively mapped to 4 consecutive symbols starting from a fifth OFDM symbol, to 4 consecutive symbols starting from a ninth OFDM symbol, and to 4 consecutive symbols starting from a13th OFDM symbol of a third slot, and SSB #7 614 maybe mapped to 4 consecutive symbols starting from a third OFDM symbol of a fourth slot.

Different analog beams may be applied to SSB #0 607, SSB #1 608, SSB #2 609, SSB #3 610, SSB #4 611, SSB #5 612, SSB #6 613, and SSB #7 614, respectively. In addition, the same analog beam may be used for all 4 OFDM symbols in which respective SSBs are transmitted, and in OFDM symbols to which no SSB is mapped, beams to be used may be freely determined at the discretion of a BS.

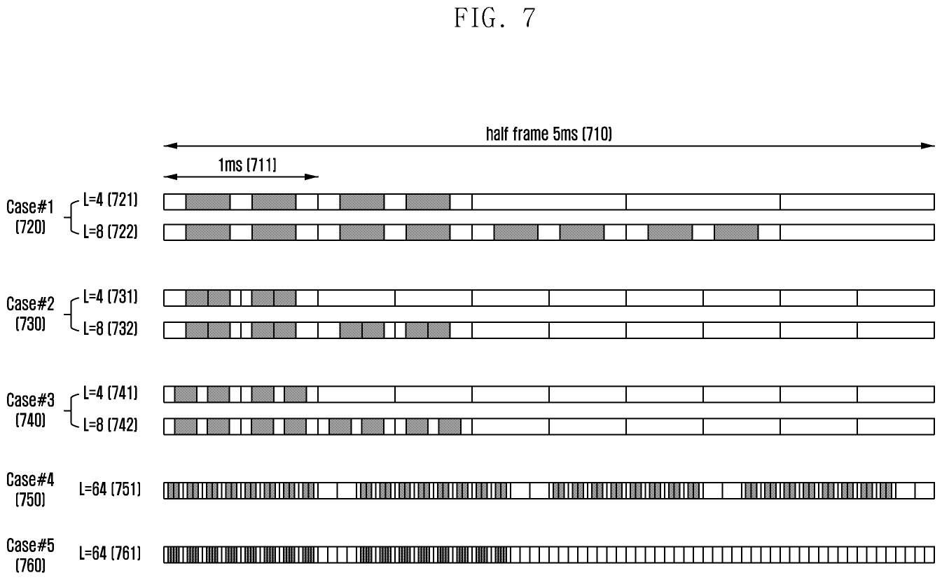

FIG. 7 illustrates transmission cases of a SSB according to subcarrier spacing within 5 ms in a wireless communication system according to an embodiment.

Referring to FIG. 7, in a 5G communication system, SSBs may be transmitted periodically at each time interval 710 of 5 ms, for example (corresponding to five subframes or half-frames).

In a frequency band of 3 GHz or below, a maximum of 4 SSBs may be transmitted within half frame 5 ms 710. In a frequency band above 3 GHz and less than or equal to 6 GHz, a maximum of 8 SSBs may be transmitted. In a frequency band above 6 GHz, a maximum of 64 SSBs may be transmitted. The subcarrier spacings of 15 kHz or 30 kHz may be used at a frequency of less than or equal to 6 GHz.

In case #1 501 including one slot with the subcarrier spacing of 15 kHz of FIG. 5, and referring to FIG. 7, SSBs may be mapped to a first slot and a second slot so that a maximum of 4 SSBs 721 may be transmitted in a frequency band of 3 GHz or below, and SSBs may be mapped to first, second, third, and fourth slots so that a maximum of 8 SSBs 722 may be transmitted in a frequency band above 3 GHz and less than or equal to 6 GHz. In case #2 502 or case #3 503 including two slots with the subcarrier spacing of 30 kHz of FIG. 5, SSBs may be mapped starting from a first slot so that a maximum of 4 SSBs 731 and 741 may be transmitted in a frequency band of 3 GHz or below, and SSBs may be mapped starting from first and third slots so that a maximum of 8 SSBs 732 and 742 may be transmitted in a frequency band above 3 GHz and less than or equal to 6 GHz.

The subcarrier spacings of 120 kHz and 240 kHz may be used at a frequency above 6 GHz. In case #4 610 of the subcarrier spacing of 120 kHz configured by two slots of FIG. 6, SSBs may be mapped starting from first, third, fifth, seventh, 11th, 13th, 15th, 17th, 21st, 23rd, 25th, 27th, 31st, 33rd, 35th, and 37th slots so that a maximum of 64 SSBs 751 may be transmitted in a frequency band above 6 GHz. In FIG. 7, and referring to case #5 620 of the subcarrier spacing of 240 kHz configured by 4 slots of FIG. 6, SSBs may be mapped starting from first, fifth, ninth, 13th, 21st, 25th, 29th, and 33rd slots so that a maximum of 64 SSBs 761 may be transmitted in a frequency band above 6 GHz.

The UE may decode the PDCCH and PDSCH, based on system information included in the received MIB, and may then acquire an SIB. The SIB may include at least one from among UL cell bandwidth-related information, a random access parameter, a paging parameter, or a UL power control-related parameter.

In general, the UE may establish a radio link with a network through a random access procedure based on system information and synchronization with the network, acquired in a cell search process. As the random access, a contention-based scheme or a contention-free scheme may be used. When the UE performs cell selection and reselection during an initial cell access operation, for example, for moving from an RRC_IDLE (RRC idle) state to an RRC_CONNECTED (RRC connected) state, the contention-based random-access scheme may be used. The contention-free scheme may be used to reconfigure UL synchronization when DL data reaches, in handover, or in location measurement. Table 3 below enumerates conditions (events) under which a random access procedure is triggered in a 5G system.

TABLE 3
- Initial access from RRC_IDLE;
- RRC Connection Re-establishment procedure;
- DL or UL data arrival during RRC_CONNECTED when UL synchronisation status is “non-
synchronised”;
- UL data arrival during RRC_CONNECTED when there are no PUCCH resources for SR
available;
- SR failure;
- Request by RRC upon synchronous reconfiguration (e.g. handover);
- RRC Connection Resume procedure from RRC_INACTIVE;
- To establish time alignment for a secondary TAG;
- Request for Other SI;
- Beam failure recovery;
- Consistent UL LBT failure on SpCell.

Hereinafter, a description will be given of a measurement time configuration method for radio resource management (RRM) based on an SSB of the 5G wireless communication system.

As configurations for SSB-based intra/inter-frequency measurements and channel state information reference signal (CSI-RS)-based intra/inter-frequency measurements, MeasObjectNR of MeasObjectToAddModList may be configured for the UE based on higher layer signaling. For example, MeasObjectNR may be configured as in Table 4 below.

TABLE 4
MeasObjectNR ::= SEQUENCE {

| | |
|---|---|
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | , |

| | |
|---|---|
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS-BlocksToAverage) |

OPTIONAL, -- Need R

| | |
|---|---|
| nrofCSI-RS-ResourcesToAverage | INTEGER (2..maxNrofCSI-RS- |

| | |
|---|---|
| ResourcesToAverage) | OPTIONAL, -- Need R |
| quantityConfigIndex | INTEGER (1..maxNrofQuantityConfig), |
| offsetMO | Q-OffsetRangeList, |

| | |
|---|---|
| cellsToRemoveList | PCI-List |

OPTIONAL, -- Need N
cellsToAddModList
OPTIONAL, -- Need N

| | |
|---|---|
| blackCellsToRemoveList | PCI-RangeIndexList |

OPTIONAL, -- Need N

| | |
|---|---|
| blackCellsToAddModList | SEQUENCE (SIZE (1..maxNrofPCI-Ranges)) OF |

PCI-RangeElement OPTIONAL, -- Need N

| | |
|---|---|
| whiteCellsToRemoveList | PCI-RangeIndexList |

OPTIONAL, -- Need N

| | |
|---|---|
| whiteCellsToAddModList | SEQUENCE (SIZE (1..maxNrofPCI-Ranges)) OF |

```
PCI-RangeElement OPTIONAL, -- Need N
  ...,
  [[
  freqBandIndicatorNR
OPTIONAL, -- Need R
```

| | |
|---|---|
| measCycleSCell | ENUMERATED {sf160, sf256, sf320, sf512, |

```
sf640, sf1024, sf1280} OPTIONAL -- Need R
  ]],
  [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

OPTIONAL -- Need M
]]
}

Terms in Table 4 may perform the following functions. However, the disclosure is not limited thereto.

ssbFrequency may configure the frequency of a synchronization signal related to MeasObjectNR.

ssbSubcarrierSpacing configures the SSB's subcarrier spacing. Only 15 kHz or 30 kHz may be applied for FR1, and only 120 kHz or 240 kHz may be applied for FR2.

smtc1 denotes an SS/PBCH block measurement timing configuration, may configure a primary measurement timing configuration, and may configure the duration and timing offset and duration for the SSB.

smtc2 may configure a secondary measurement timing configuration for an SSB related to MeasObjectNR having a PCI listed in pci-List.

In addition, the configurations may be configured based on any other higher layer signaling. For example, the SMTC may be configured for the UE based on SIB2 for intra-frequency, inter-frequency, and inter-RAT reselection or based on reconfigurationWithSync for NR PSCell change and NR PCell change, and the SMTC may be configured for the UE based on SCellConfig for NR SCell addition.

The UE may configure a first SMTC according to periodictiyAndOffset (providing periodicity and offset) based on smtc1 configured based on higher layer signaling for SSB measurement. A first subframe of each SMTC occasion may start from a subframe of an SpCell and an SFN which satisfy conditions in Table 5 below.

TABLE 5

```
SFN mod T = (FLOOR (Offset/10));
if the Periodicity is larger than sf5:
  subframe = Offset mod 10;
else:
  subframe = Offset or (Offset +5);
with T = CEIL(Periodicity/10).
```

If smtc2 is configured, for cells indicated by pci-List values of smtc2 in the same MeasObjectNR, the UE may configure an additional SMTC according to the periodicity of configured smtc2 and the offset and duration of smtc1. For the same frequency (e.g., a frequency for intra frequency cell reselection) or different frequencies (e.g., frequencies for inter frequency cell reselection), the UE may be configured with smtc and measure an SSB, based on smtc3list for smtc2-LP (with long periodicity) and integrated access and backhaul-mobile termination (IAB-MT). The UE may not consider SSBs transmitted in subframes other than the SMTC occasion for SSB-based RRM measurement in configured ssbFrequency.

Depending on a serving cell configuration and PCI configuration, the BS may use various multi-transmit/receive point or transmission and reception point (TRP) operation schemes. Among them, if two TRPs located at a physical distance have different PCIs, there may be two methods for operating the two TRPs.

### Operation Method 1

Two TRPs having different PCIs may be operated with two serving cell configurations.

The BS may include, in different serving cell configurations, channels and signals transmitted in different TRPs so as to configure the same using Method 1. That is, respective TRPs have independent serving cell configurations, and frequency band values FrequencyInfoDL indicated by DownlinkConfigCommon in respective serving cell configurations may indicate at least partially overlapping bands. Since multiple TRPs operate based on multiple ServCellIndexes (e.g., ServCellIndex #1 and ServCellIndex #2), respective TRPs may use separate PCIs. That is, the BS may assign one PCI for each ServCellIndex.

In case that multiple SSBs are transmitted at TRP 1 and TRP 2, the SSBs have different PCIs (for example, PCI #1 and PCI #2), and the BS may select an appropriate value of ServCellIndex indicated by a cell parameter in quasi co-located (QCL)-Info, may map suitable PCIs to respective TRPs, and may designate the SSB transmitted at one of TRP 1 or TRP 2 as the source reference (RS) of QCL configuration information. However, such configurations have a problem in that the degree of freedom of CA configurations is limited, or the signaling burden is increased, because one serving cell configuration that may be used for the UE's carrier aggregation (CA) is applied to multiple TRPs.

### Operation Method 2

Two TRPs having different PCIs may be operated with one serving cell configuration.

The BS may configure, through one serving cell configuration, channels and signals transmitted in different TRPs using Method 2. Since the UE operates based on one ServCellIndex (e.g., ServCellIndex #1), it is not possible to recognize the PCI (e.g., PCI #2) assigned to the second TRP. Compared with Operation Method 1 described above, Operation Method 2 may have a degree of freedom in connection with CA configurations, but if multiple SSBs are transmitted at TRP 1 and TRP 2, the SSBs have different PCIs (e.g., PCI #1 and PCI #2), and the BS may fail to map the PCI (for example, PCI #2) of the second TRP through the ServCellIndex indicated by a cell parameter in QCL-Info. The BS may be able to designate only an SSB transmitted in TRP 1 as a source reference (RS) of QCL configuration information, and may not be able to designate an SSB transmitted in TRP 2.

Operation Method 1 may perform multi-TRP operation for two TRPs having different PCIs through an additional serving cell configuration without additional specification support, but Operation Method 2 may operate based on additional UE capability reporting and BS configuration information as described below.

### UE Capability Report for Operation Method 2

The UE may report, to the BS through UE capability, that configuration of an additional PCI different from a PCI of a serving cell is possible from the BS via higher layer signaling. The UE capability may include X1 and X2 which are numbers independent of each other, or each of X1 and X2 may be reported via independent UE capability.

X1 refers to the maximum number of additional PCIs that may be configured for the UE, the PCIs may differ from the serving cell's PCI, and the time domain position and periodicity of the SSB corresponding to the additional PCIs may indicate that the same is identical to the serving cell's SSB.

X2 refers to the maximum number of additional PCIs that may be configured for the UE, the PCIs may differ from the serving cell's PCI, and the time domain position and periodicity of the SSB corresponding to the additional PCIs may indicate that the same is different from the SSB corresponding to PCIs reported by X1.

PCIs corresponding to values reported with X1 and X2 may not be configured simultaneously with each other.

The values reported with X1 and X2 reported through the UE capability report may each have an integer value from 0 to 7.

The values reported with X1 and X2 may be reported as different values in FR1 and FR2.

### Higher Layer Signaling Configuration for Operation Method 2

The UE may be configured with SSB-MTCAdditionalPCI-r17, which is higher layer signaling, from the BS, based on the above-described UE capability report, multiple additional PCIs having different values from at least the serving cell, SSB transmission power corresponding to each of the additional PCIs, and ssb-PositionInBurst corresponding to the each of the additional PCIs may be included in the corresponding higher layer signaling, and a maximum of 7 additional PCIs may be configurable.

On an SSB corresponding to an additional PCI having a value different from that of a serving cell, the UE may assume that a center frequency, a subcarrier spacing, and a subframe number offset for the SSB is the same as that for the SSB of the serving cell.

The UE may assume that an RS (for example, SSB or CSI-RS) corresponding to the serving cell's PCI is always connected to an activated TCI state, and may assume that when one or multiple additionally configured PCIs having a different value from the serving cell, only one of the PCIs is connected to the activated TCI state.

If the UE has been configured with two different corsesetPoolIndexes, the reference RS corresponding to the serving cell PCI is connected to one or more activated TCI states, and an RS corresponding to the additionally configured PCI having a value different from that of the serving cell is connected to one or more activated TCI states, the UE may expect that the activated TCI state(s) connected to the serving cell PCI is connected to one coresetPoolIndex out of two, and that the activated TCI state(s) connected to the additionally configured PCI having a value different from that of the serving cell is connected to the remaining one coresetPoolIndex.

Based on the higher layer signaling of the BS and the UE capability reporting for Operation Method 2 described above, the additional PCI having a value different from the PCI of the serving cell may be configured. If there is no configuration, the SSB, which cannot be designated by an RS and which corresponds to the additional PCI having a value different from that of the PCI of the serving cell, may be used to designate an RS of QCL configuration information. This SSB may be used to serve as a QCL RS to support operations of multiple TRPs having different PCIs, unlike the SSB configurable to be used for purposes, such as RRM, mobility, or handover, such as configuration information about the SSB configurable in smtc1 and smtc2 of higher layer signaling.

Next, a demodulation reference signal (DMRS) which is one of reference signals in 5G systems will be described in detail.

A DMRS may include multiple DMRS ports, and each of the ports may maintain orthogonality by using code division multiplexing (CDM) or frequency division multiplexing (FDM) so as to prevent interference with each other. However, the term DMRS may be expressed by other terms depending on a user's intention or the purpose of use of the reference signal. The term DMRS is only an example presented to easily describe the technical details of the disclosure and to help understanding of the disclosure, and is not intended to limit the scope of the disclosure. That is, it will be apparent to those skilled in the art that the technical idea of the disclosure is applicable to any reference signal.

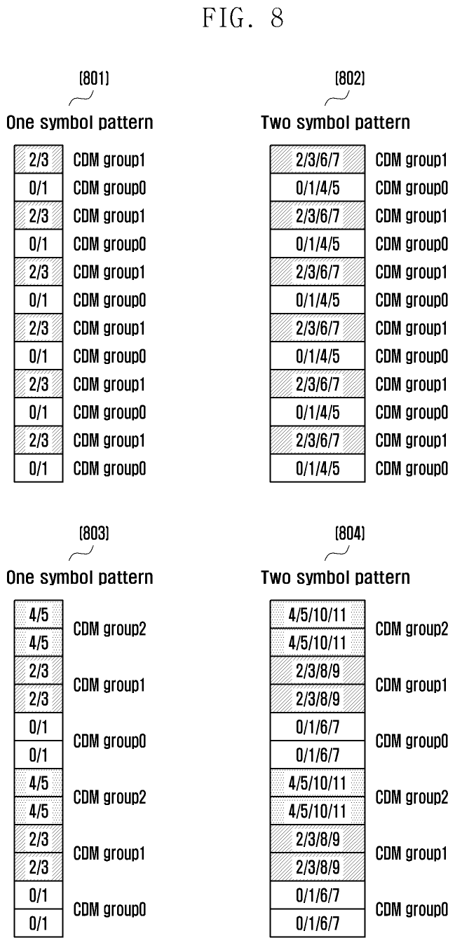

FIG. 8 illustrates an example for explaining DMRS patterns (type1 and type2) used for communication between a BS and a UE in a wireless communication system according to an embodiment.

In the 5G system, two DMRS patterns may be supported.

Referring to FIG. 8, DMRS type1 801, 802 are illustrated, and specifically a 1-symbol pattern 801 and a 2-symbol pattern 802 are shown. DMRS type1 801, 802 is a DMRS pattern with a comb 2 structure which may include two CDM groups, and the different CDM groups may be FDMed.

In the 1-symbol pattern 801, CDM on frequency may be applied to the same CDM group so that two DMRS ports may be distinguished, and therefore a total of four orthogonal DMRS ports may be configured. The 1-symbol pattern 801 may include a DMRS port ID mapped to each CDM group. In the 2-symbol pattern 802, CDM on time/frequency may be applied to the same CDM group so that four DMRS ports may be distinguished, and therefore a total of eight orthogonal DMRS ports may be configured. The 2-symbol pattern 802 may include a DMRS port ID mapped to each CDM group.

Referring to FIG. 8, DMRS type2 803, 804 is a DMRS pattern with a structure in which frequency domain orthogonal cover codes (FD-OCCs) are applied to a subcarrier adjacent on frequency, and may include three CDM groups, and different CDM groups may be FDMed.

In the 1-symbol pattern 803, CDM on frequency may be applied to the same CDM group so that two DMRS ports may be distinguished, and therefore a total of six orthogonal DMRS ports may be configured. The 1-symbol pattern 803 may include a DMRS port ID mapped to each CDM group. In the 2-symbol pattern 704, CDM on time/frequency may be applied to the same CDM group so that four DMRS ports may be distinguished, and therefore a total of 12 orthogonal DMRS ports may be configured. The 2-symbol pattern 804 may include a DMRS port ID mapped to each CDM group.

In an NR system, two different DMRS patterns (e.g., the DMRS type1 801, 802 or the DMRS type2 803, 804) may be configured, and whether each DMRS pattern is a one-symbol pattern 801 or 803 or is an adjacent two-symbol pattern 802 or 804 may also be configured. Not only a DMRS port number may be scheduled, but also the number of CDM groups scheduled together for PDSCH rate matching may be configured and signaled. In cyclic prefix based OFDM (CP-OFDM), both the two DMRS patterns described above may be supported in DL and UL, and in a discrete Fourier transform spread OFDM (DFT-S-OFDM), only DMRS type1 801, 802 among the DMRS patterns described above may be supported in UL.

In addition, configurable additional DMRSs may also be supported. A front-loaded DMRS may refer to a first DMRS transmitted and received in the front-most symbol in the time domain from among DMRSs, and additional DMRSs may refer to DMRSs transmitted and received in symbols subsequent to the front-loaded DMRS in the time domain. In the NR system, a minimum of 0 to a maximum of 3 additional DMRSs may be configured. If additional DMRSs are configured, the same pattern as the front-loaded DMRS may be assumed. When information on whether the aforementioned DMRS pattern type for the front-loaded DMRS is type1 or type2, information on whether the DMRS pattern is a one-symbol pattern or is an adjacent two-symbol pattern and information on a DMRS port and the number of CDM groups used are indicated, and when information on DMRS port and the number of CDM groups used are indicated, if an additional DMRS is additionally configured, the additional DMRS may be assumed to be configured with the same DMRS information as that for the front-loaded DMRS.

The DL DMRS configuration described above may be configured based on RRC signaling as given in Table 6 below.

TABLE 6

| DMRS-DownlinkConfig ::= | SEQUENCE { | |
|---|---|---|
| dmrs-Type | ENUMERATED {type2} | OPTIONAL, |

-- Need S

| | | |
|---|---|---|
| dmrs-AdditionalPosition | ENUMERATED {pos0, pos1, pos3} | OPTIONAL, |

-- Need S

| | | |
|---|---|---|
| maxLength | ENUMERATED {len2} | OPTIONAL, |

-- Need S

| | | |
|---|---|---|
| scramblingID0 | INTEGER (0..65535) | OPTIONAL, |

-- Need S

| | | |
|---|---|---|
| scramblingID1 | INTEGER (0..65535) | OPTIONAL, |

-- Need S

| | | |
|---|---|---|
| phaseTrackingRS | SetupRelease {PTRS-DownlinkConfig} | OPTIONAL, |

-- Need M
...
}

In Table 6, dmrs-Type may configure a DMRS type, dmrs-AdditionalPosition may configure additional DMRS OFDM symbols, maxLength may configure a 1-symbol DMRS pattern or a 2-symbol DMRS pattern, scramblingID0 and scramblingID1 may configure scrambling IDs, and phase TrackingRS may configure a phase tracking reference signal (PTRS).

In addition, the UL DMRS configuration described above may be configured based on RRC signaling as given in Table 7 below.

TABLE 7

| DMRS-UplinkConfig ::= | SEQUENCE { | |
|---|---|---|
| dmrs-Type | ENUMERATED {type2} | OPTIONAL, -- |

Need S

| | | |
|---|---|---|
| dmrs-AdditionalPosition | ENUMERATED {pos0, pos1, pos3} | OPTIONAL, |

-- Need R

| | | |
|---|---|---|
| phaseTrackingRS | SetupRelease { PTRS-UplinkConfig } | OPTIONAL, |

-- Need M

| | | |
|---|---|---|
| maxLength | ENUMERATED {len2} | OPTIONAL, |

-- Need S

| transformPrecodingDisabled | SEQUENCE { | |
|---|---|---|
| scramblingID0 | INTEGER (0..65535) | OPTIONAL, |

-- Need S

| | | |
|---|---|---|
| scramblingID1 | INTEGER (0..65535) | OPTIONAL, |

-- Need S
...

| | |
|---|---|
| } | OPTIONAL, |

-- Need R

| transformPrecodingEnabled | SEQUENCE { | |
|---|---|---|
| nPUSCH-Identity | INTEGER (0..1007) | OPTIONAL, |

-- Need S

| | | |
|---|---|---|
| sequenceGroupHopping | ENUMERATED {disabled} | OPTIONAL, |

-- Need S

| | | |
|---|---|---|
| sequenceHopping | ENUMERATED {enabled} | OPTIONAL, |

-- Need S

| | |
|---|---|
| ... | OPTIONAL, |

```
  }
-- Need R
  ...
}
```

In Table 7, dmrs-Type may configure a DMRS type, dmrs-AdditionalPosition may configure additional DMRS OFDM symbols, phaseTrackingRS may configure a PTRS, and maxLength may configure a 1-symbol DMRS pattern or a 2-symbol DMRS pattern. ScramblingID0 and scramblingID1 may configure scrambling ID0s, nPUSCH-Identity may configure a cell ID for DFT-s-OFDM, sequenceGroupHopping may disable sequence group hopping, and sequenceHopping may enable sequence hopping.

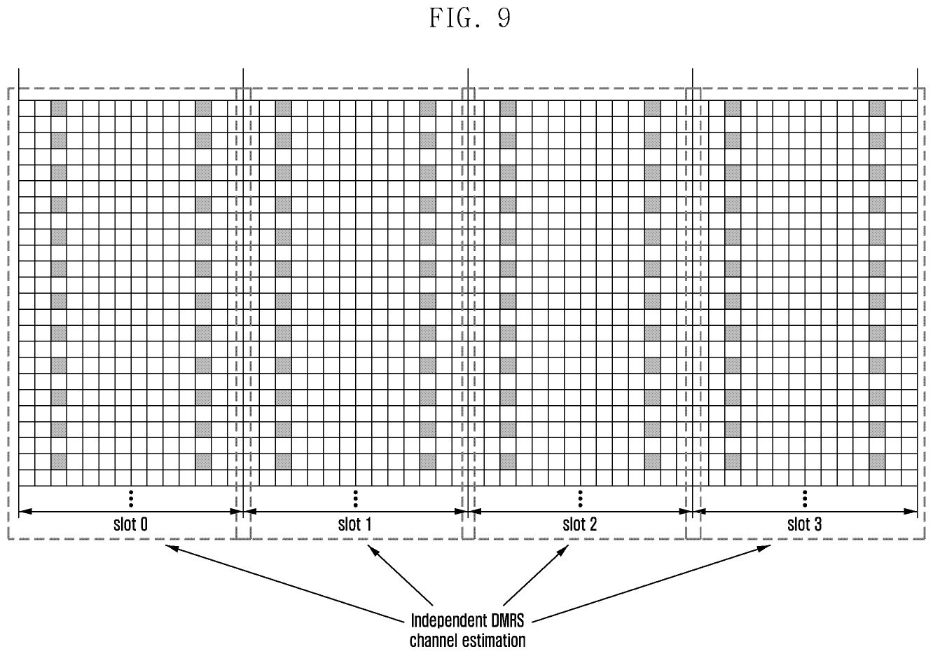

FIG. 9 illustrates channel estimation using DMRS received from one PUSCH in a time band of a wireless communication system according to an embodiment.

Referring to FIG. 9, in performing channel estimation for data decoding using a DMRS, the channel estimation may be performed within a precoding resource block group (PRG), which is a corresponding bundling unit, by using physical resource block (PRB) bundling linked to a system band in a frequency band. In addition, the channel estimation may be performed by assuming that, in a time unit, only a DMRS received from one PUSCH has the same precoding.

Hereinafter, a time domain resource allocation (TDRA) method for a data channel in a 5G system will be described. A BS may configure a table for time domain resource allocation information (TDRA) regarding a PDSCH and a PUSCH for a UE through upper layer signaling (e.g., RRC signaling).

The BS may configure a table including a maximum of maxNrofDL-Allocations=17 entries for the PDSCH, and may configure a table including a maximum of maxNrofUL-Allocations=17 entries for the PUSCH. The TDRA information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (e.g., corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like.

The TDRA information for the PDSCH, as given in Table 8 below, may be configured to the UE through RRC signaling.

TABLE 8
PDSCH-TimeDomainResourceAllocationList information element

PDSCH-TimeDomainResourceAllocationList ::= SEQUENCE (SIZE(1..maxNrofDL-
Allocations)) OF PDSCH-TimeDomainResourceAllocation
PDSCH-TimeDomainResourceAllocation ::= SEQUENCE {

| | | |
|---|---|---|
| k0 | INTEGER(0..32) | OPTIONAL, -- |

Need S

| | |
|---|---|
| mappingType | ENUMERATED {typeA, typeB}, |
| startSymbolAndLength | INTEGER (0..127) |
| repetitionNumber | ENUMERATED {n2, n3, n4, n5, n6, n7, n8, n16} |

OPTIONAL, -- Cond Formats1-0and1-1
}

In Table 8, k0 may denote PDCCH-to-PDSCH timing (i.e., a slot offset between DL control information (DCI) and a PDSCH scheduled thereby) in slot unit, mappingType may denote the mapping type of the PDSCH, startSymbolAndLength may denote a start symbol of the PDSCH and the length thereof, and repetitionNumber may denote the number of transmission occasions of the PDSCH according to slot-based repetition schemes.

The TDRA information for the PUSCH, as given in Table 9 below, may be configured to the UE through RRC signaling.

TABLE 9
PUSCH-TimeDomainResourceAllocation information element

| | |
|---|---|
| PUSCH-TimeDomainResourceAllocationList ::= SEQUENCE | (SIZE(1..maxNrofUL- |

Allocations)) OF PUSCH-TimeDomainResourceAllocation

| PUSCH-TimeDomainResourceAllocation ::= | SEQUENCE { | |
|---|---|---|
| k2 | INTEGER(0..32) | OPTIONAL, -- |

Need S

| | |
|---|---|
| mappingType | ENUMERATED {typeA, typeB}, |
| startSymbolAndLength | INTEGER (0..127) |

}
PUSCH-Allocation-r16 ::= SEQUENCE {

| | | |
|---|---|---|
| mappingType-r16 | ENUMERATED {typeA, typeB} | OPTIONAL, -- |

Cond NotFormat01-02-Or-TypeA

| | | |
|---|---|---|
| startSymbolAndLength-r16 | INTEGER (0..127) | OPTIONAL, -- Cond |

NotFormat01-02-Or-TypeA

| | | |
|---|---|---|
| startSymbol-r16 | INTEGER (0..13) | OPTIONAL, -- Cond Rep TypeB |
| length-r16 | INTEGER (1..14) | OPTIONAL, -- Cond RepTypeB |

| | |
|---|---|
| numberOfRepetitions-r16 | ENUMERATED {n1, n2, n3, n4, n7, n8, n12, n16} |

OPTIONAL, -- Cond Format01-02
...
}

In Table 9, k2 may denote PDCCH-to-PUSCH timing (i.e., a slot offset between DCI and a PUSCH scheduled thereby) in slot unit, mappingType may denote the mapping type of the PUSCH, startSymbolAndLength or StartSymbol and length may denote a start symbol of the PUSCH and the length thereof, and numberOfRepetitions may denote the number of repetitions applied to transmission of the PUSCH.

The BS may notify the UE of at least one of the entries of the TDRA information table described above through L1 signaling (e.g., DCI) (e.g., may be indicated by “time domain resource allocation” field inside DCI). The UE may acquire TDRA information regarding a PDSCH or PUSCH, based on the DCI acquired from the BS.

Hereinafter, physical uplink shared channel (PUSCH) transmission in a 5G system will be described. PUSCH transmission may be dynamically scheduled by a UL grant inside DCI (e.g., referred to as dynamic grant (DG)-PUSCH), or may be scheduled by means of configured grant Type 1 or configured grant Type 2 (e.g., referred to as configured grant (CG)-PUSCH). Dynamic scheduling for PUSCH transmission may be indicated by DCI format0_0 or 0_1.

Configured grant Type 1 PUSCH transmission may be configured semi-statically by receiving configuredGrantConfig including rrc-ConfiguredUplinkGrant in Table 10 below through higher layer signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGran in Table 10 through higher layer signaling.

If PUSCH transmission is operated by a configured grant, parameters applied to the PUSCH transmission are applied through configuredGrantConfig (higher layer signaling) in Table 10 except for dataScramblingIdentityPUSCH, txConfig, codebookSubset, maxRank, and scaling of UCI-OnPUSCH, which are provided by pusch-Config (higher layer signaling) in Table 11. If provided with transformPrecoder inside configuredGrantConfig (higher layer signaling) in Table 10, the UE applies tp-pi2BPSK inside pusch-Config in Table 11 to PUSCH transmission operated by a configured grant.

TABLE 10
ConfiguredGrantConfig

| | |
|---|---|
| ConfiguredGrantConfig ::= | SEQUENCE { |
| frequencyHopping | ENUMERATED {intraSlot, interSlot} OPTIONAL, |

-- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } OPTIONAL, |

-- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..17), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |

```
  sym2, sym7, sym1x14, sym2x14, sym4x14, sym5x14, sym8x14, sym10x14, sym17x14,
sym20x14,
  sym32x14, sym40x14, sym64x14, sym80x14, sym128x14, sym170x14, sym256x14,
sym320x14, sym512x14,
  sym640x14, sym1024x14, sym1280x14, sym2560x14, sym5120x14,
  sym6, sym1x12, sym2x12, sym4x12, sym5x12, sym8x12, sym10x12, sym17x12,
sym20x12, sym32x12,
  sym40x12, sym64x12, sym80x12, sym128x12, sym170x12, sym256x12, sym320x12,
sym512x12, sym640x12,
  sym1280x12, sym2560×12
  },
```

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..16), |
| frequencyDomainAllocation | BIT STRING (SIZE(18)), |
| antennaPort | INTEGER (0..31), |

| | |
|---|---|
| dmrs-SeqInitialization | INTEGER (0..1) |

OPTIONAL, -- Need R

| | |
|---|---|
| precodingAndNumberOfLayers | INTEGER (0..63), |

| | |
|---|---|
| srs-ResourceIndicator | INTEGER (0..16) |

OPTIONAL, -- Need R

| | |
|---|---|
| mcsAndTBS | INTEGER (0..31), |

| | |
|---|---|
| frequencyHoppingOffset | INTEGER (1.. |

| | |
|---|---|
| maxNrofPhysicalResourceBlocks-1) | OPTIONAL, -- Need R |

| | |
|---|---|
| pathlossReferenceIndex | INTEGER (0..maxNrofPUSCH- |

```
PathlossReferenceRSs-1),
    ...
  }
OPTIONAL, -- Need R
  ...
}
```

Next, a PUSCH transmission method will be described. The DMRS antenna port for PUSCH transmission is identical to an antenna port for sounding reference signal (SRS) transmission. PUSCH transmission may follow a codebook-based transmission method and anon-codebook-based transmission method according to whether the value oftxConfig inside pusch-Config in Table 7 above, which is higher signaling, is “codebook” or “nonCodebook”. PUSCH transmission may be dynamically scheduled through DCI format 0_0 or 0_1, and may be semi-statically configured based on a configured grant.

Upon receiving indication of scheduling regarding PUSCH transmission through DCI format 0_0, the UE may perform beam configuration for PUSCH transmission by using pucch-spatialRelationInfoID corresponding to a UE-specific PUCCH resource having the minimum ID inside an activated UL BWP in a serving cell. The PUSCH transmission may be performed based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 11 below, the UE does not expect scheduling through DCI format 0_1.

TABLE 11
PUSCH-Config

| | |
|---|---|
| PUSCH-Config ::= | SEQUENCE { |
| dataScramblingIdentityPUSCH | INTEGER (0..1023) OPTIONAL, -- |

Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | OPTIONAL, -- Need M |
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |
| maxNrofPhysicalResourceBlocks-1) | OPTIONAL, -- Need M |

| | |
|---|---|
| resourceAllocation | ENUMERATED { resourceAllocation Type0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | | |
|---|---|---|
| codebookSubset | ENUMERATED | {fullyAndPartialAndNonCoherent, |

partialAndNonCoherent,nonCoherent}

| | OPTIONAL, -- Cond codebookBased | |
|---|---|---|
| maxRank | INTEGER (1..4) | OPTIONAL, -- |

Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (higher signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. The TPMI and the transmission rank may be given through “precoding information and number of layers” (a field inside DCI) or configured through precodingAndNumberOfLayers (higher signaling). The TPMI may be used to indicate a precoder to be applied to PUSCH transmission.

The precoder to be used for PUSCH transmission may be selected from an Uplink codebook having the same number of antenna ports as the value of nrofSRS-Ports inside SRS-Config (higher signaling). In connection with codebook-based PUSCH transmission, the UE may determine a codebook subset, based on codebookSubset inside pusch-Config (higher signaling) and TPMI. The codebookSubset inside pusch-Config (upper signaling) may be configured to be one of “fully AndPartialAndNonCoherent”, “partialAndNonCoherent”, or “noncoherent”, based on UE capability reported by the UE to the BS.

If the UE reported “partialAndNonCoherent” as UE capability, the UE may not expect that the value of codebookSubset (higher signaling) will be configured as “fully AndPartialAndNonCoherent”. If the UE reported “noncoherent” as UE capability, the UE may not expect that the value of codebookSubset (higher signaling) will be configured as “fully AndPartialAndNonCoherent” or “partilaAndNonCoherent”. If nrofSRS-Ports inside SRS-ResourceSet (upper signaling) indicates two SRS antenna ports, the UE may not expect that the value of codebookSubset (higher signaling) will be configured as “partial AndNonCoherent”.

The UE may have one SRS resource set configured therefor, wherein the value of usage inside SRS-ResourceSet (higher signaling) is “codebook”, and one SRS resource may be indicated through an SRI inside the corresponding SRS resource set. If multiple SRS resources are configured inside the SRS resource set wherein the value of usage inside SRS-ResourceSet (higher signaling) is “codebook”, the UE expects that the value of nrofSRS-Ports inside SRS-Resource (upper signaling) is identical for all SRS resources.

The UE transmits, to the BS, one or multiple SRS resources included in the SRS resource set wherein the value of usage is configured as “codebook” according to upper signaling, and the BS selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the BS may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Next, non-codebook-based PUSCH transmission will be described. PUSCH transmission may be dynamically scheduled through DCI format 0_0 or 0_1, and may be semi-statically configured based on a configured grant. If at least one SRS resource is configured inside an SRS resource set wherein the value of usage inside SRS-ResourceSet (higher signaling) is “nonCodebook”, non-codebook-based PUSCH transmission may be scheduled for the UE through DCI format 0_1.

With regard to the SRS resource set wherein the value of usage inside SRS-ResourceSet (higher signaling) is “nonCodebook”, one non-zero-power (NZP) CSI-RS resource associated with the SRS resource set may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than a specific number of symbols (e.g., 42 symbols), the UE may not expect that information regarding the precoder for SRS transmission will be updated.

If the configured value of resourceType inside SRS-ResourceSet (higher signaling) is “aperiodic”, the connected NZP CSI-RS may be indicated by an SRS request which is a field inside DCI format 0_1 or 1_1. If the NZP CSI-RS resource associated with the SRS-ResourceSet is an aperiodic NZP CSI-RS resource and the value of field SRS request inside DCI format 0_1 or 1_1 is not “00”, this case may indicate that the NZP CSI-RS associated with the SRS-ResourceSet exists. If the value of SRS request indicates the existence of a NZP CSI-RS, the NZP CSI-RS may be located in the slot used to transmit the PDCCH including the SRS request field. TCI states configured for the scheduled subcarrier may not be configured as QCL-TypeD.

If there is a periodic or semi-persistent SRS resource set configured, the connected NZP CSI-RS may be indicated through associatedCSI-RS inside SRS-ResourceSet (higher signaling). With regard to non-codebook-based transmission, the UE may not expect that spatialRelationInfo which is upper signaling regarding the SRS resource and associatedCSI-RS inside SRS-ResourceSet (higher signaling) will be configured together.

If multiple SRS resources are configured for the UE, the UE may determine a precoder to be applied to PUSCH transmission and the transmission rank, based on an SRI indicated by the BS. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the BS by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The BS may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the BS, one or multiple SRS resources inside the SRS resource set wherein the configured usage is “nonCodebook”, and the BS may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the BS may be the number of transmission layers of the PUSCH, and the UE may transmit the PUSCH by applying the precoder applied to SRS resource transmission to each layer.

Transmission repetition of a PUSCH in the 5G system and a method of transmitting a single transport block (TB) over multiple slots will now be described.

The 5G system may support two types of repeated transmission methods of the UL data channel (e.g., PUSCH repetition type A transmission, PUSCH repetition type B transmission) and TB processing over multi-slot PUSCH (TBoMS) for transmitting a single TB through multiple PUSCHs over multiple slots. The UE may receive configuration of either PUSCH repetition type A or type B transmission based on higher layer signaling and may transmit TBoMS by receiving configuration of numberOfSlotsTBoMS based on a resource allocation table.

### PUSCH Repetition Type A Transmission

Within one slot, by a TDRA method, a start symbol and a length of a UL data channel may be determined, and the BS may transmit the number of repeated transmissions to the UE based on higher layer signaling (e.g., RRC signaling) or L1 signaling (e.g., DCI). The number (N) of slots configured based on numberOfSlotsTBoMS to determine the TB size (TBS) is 1.

The UE may repeatedly transmit a UL data channel, which has the same start symbol and length as the UL data channel configured above, in consecutive slots, based on the number of transmission repetitions received from the BS. If at least one symbol among symbols in a slot configured to be a DL by the BS for the UE or in a slot for UL data channel transmission repetition configured for the UE is configured to be a DL, the UE may skip UL data channel transmission in the corresponding slot. F For example, the UE may not transmit the UL data channel within the number of UL data channel transmission repetitions. In contrast, the UE supporting the relevant standard repeated UL data transmission may determine that a slot capable of performing UL data transmission repetition is an available slot, and may count the number of transmissions during UL data channel transmission repetition in the slot determined to be an available slot. If the UL data channel transmission repetition in a slot determined to be an available slot is skipped, the UE may perform transmission repetition based on a slot available for transmission after postponing. Using Table 12 below, redundancy versions may be applied according to redundancy patterns configured for each nth PUSCH transmission occasion.

### PUSCH Repetition Type B Transmission

Within one slot, by a TDRA method, a start symbol and a length of a UL data channel may be determined, and the BS may transmit the number of transmission repetitions, numberofrepetitions, to the UE based on higher layer signaling (e.g., RRC signaling) or L1 signaling (e.g., DCI). The number N of slots configured based on numberOfSlotsTBoMS to determine the TBS is 1.

Based on the configured start symbol and length of the UL data channel, nominal repetition of the UL data channel may be determined as follows. As used herein, nominal repetition may refer to symbol resources configured by the BS for PUSCH transmission repetition, and the UE may determine resources that may be used as the UL from the configured nominal repetition. In this case, the slot in which the n^{th} nominal repetition starts is given by

$${K}_{s} + ⌊ \frac{S + n \cdot L}{{N}_{symb}^{slot}} ⌋ ,$$

and the symbol starting in that slot is given by

$$mod ( S + n \cdot L , {N}_{s y m b}^{slot} ) .$$

The slot in which the n^{th} nominal repetition ends is given by

$${K}_{s} + ⌊ \frac{S + ( n + 1 ) \cdot L - 1}{{N}_{s y m b}^{s l o t}} ⌋ ,$$

and the symbol ending in that slot is given by

$$mod ( S + ( n + 1 ) \cdot L - 1 , {N}_{s y m b}^{slot} ) . n = 0 , … ,$$

numberofrepetitions−1, S may denote the configured start symbol of the UL data channel, and L may indicate the configured symbol length of the UL data channel. Kₛ refers to the slot in which PUSCH transmission starts, and

$${N}_{s y m b}^{slot}$$

refers to the number of symbols per slot.

The UE may determine an invalid symbol for PUSCH repetition type B transmission. A symbol configured as the DL by tdd-UL-DL-ConfigurationCommon or tdd-UL-DL-ConfigurationDedicated may be determined as the invalid symbol for PUSCH repeated transmission type B. Additionally, an invalid symbol may be configured based on a higher layer parameter (e.g., InvalidSymbolPattern). As an example, a higher layer parameter (e.g., InvalidSymbolPattern) may provide a symbol-level bitmap in one slot or over two slots so that an invalid symbol may be configured. In an embodiment, “1” indicated in a bitmap may represent an invalid symbol. Additionally, a period and a pattern of the bitmap may be configured based on a higher layer parameter (e.g., periodicityAndPattern). If the higher layer parameter (e.g., InvalidSymbolPattern) is configured, and InvalidSymbolPatternIndicator-ForDCIFormat0_1 or InvalidSymbolPatternIndicator-ForDCIFormat0_2 parameter indicates 1, the UE may apply an invalid symbol pattern and, if the parameter indicates 0, the UE may not apply the invalid symbol pattern. Alternatively, if the higher layer parameter (e.g., InvalidSymbolPattern) is configured, and InvalidSymbolPatternIndicator-ForDCIFormat0_1 or InvalidSymbolPatternIndicator-ForDCIFormat0_2 parameter is not configured, the UE may apply the invalid symbol pattern.

After invalid symbols are determined in respective nominal repetitions, the UE may consider symbols other than the determined invalid symbol as valid symbols. If respective nominal repetitions include one or more valid symbols, the nominal repetitions may include one or more actual repetitions. Respective actual repetitions may refer to symbols actually used for PUSCH repeated transmission from among symbols configured to be the configured nominal repetition, and may include a consecutive set of valid symbols available for PUSCH repeated transmission type B in one slot. If an actual repetition having one symbol is configured to be valid, except the case in which the configured symbol length L of the UL data channel is 1 (L=1), the UE may skip actual repetition transmission. Using Table 12 below, redundancy versions may be applied according to redundancy patterns configured for each nth PUSCH transmission occasion.

### TB Processing Over Multiple Slots (TBoMS)

Within one slot, by using a TDRA method, a start symbol and a length of a UL data channel may be determined, and the BS may transmit the number of repeated transmissions to the UE based on higher layer signaling (e.g., RRC signaling) or L1 signaling (e.g., DCI). In an embodiment, a TBS may be determined using an N value equal to or greater than 1, which is the number of slots configured based on memberOfSlotsTBoMS.

The UE may transmit a UL data channel, which has the same start symbol and length as the configured UL data channel above, in consecutive slots, based on the number of repeated transmissions and the number of slots for determining the TBS received from the BS. If at least one symbol among symbols in a slot for UL data channel transmission repetition configured for the UE or a slot configured as the DL by the BS for the UE is configured to be the DL, the UE may skip UL data channel transmission in the corresponding slot. For example, although the UL data channel is included in the number of UL data channel transmission repetitions, the UE may not transmit the same.

In contrast, the UE supporting the relevant standard repeated UL data transmission may determine that a slot capable of performing repeated UL data transmission is an available slot, and may count the number of transmissions during repeated UL data channel transmission in the slot determined to be an available slot. If the UL data channel transmission repetition in a slot determined as an available slot is skipped, the UE may perform transmission repetition based on a slot available for transmission after postponing. Using Table 12 below, redundancy versions may be applied according to redundancy patterns configured for each nth PUSCH transmission occasion.

TABLE 12

| | rv_{id} to be applied to n^{th} transmission occasion (repetition Type A) or | | | |
|---|---|---|---|---|
| | TB processing over multiple slots) or n^{th} actual repetition | | | |
| rv_{id} indicated by | (repetition Type B) | | | |
| the DCI | ((n − (n mod | ((n − (n mod | ((n − (n mod | ((n − (n mod |
| scheduling the | N))/N) mod 4 = | N))/N) mod 4 = | N))/N) mod 4 = | N))/N) mod 4 = |
| PUSCH | 0 | 0 | 0 | 0 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Hereinafter, a method for determining an uplink available slot for single- or multi-PUSCH transmission in a 5G system will be described.

If Available SlotCounting is configured to be enabled for the UE, the UE may determine an available slot for PUSCH repetition type A transmission and TBoMS PUSCH transmission, based on tdd-UL-DL-ConfigurationCommon, tdd-UL-DL-ConfigurationDedicated, ssb-PositionsInBurst, and a TDRA information field value. That is, when, in a slot for PUSCH transmission, at least one symbol configured based on TDRA for PUSCH overlaps at least one symbol having a purpose other than UL transmission, the slot may be determined to be an unavailable slot.

The following describes a method of reducing SSB density based on dynamic signaling for base station energy savings in the 5G system.

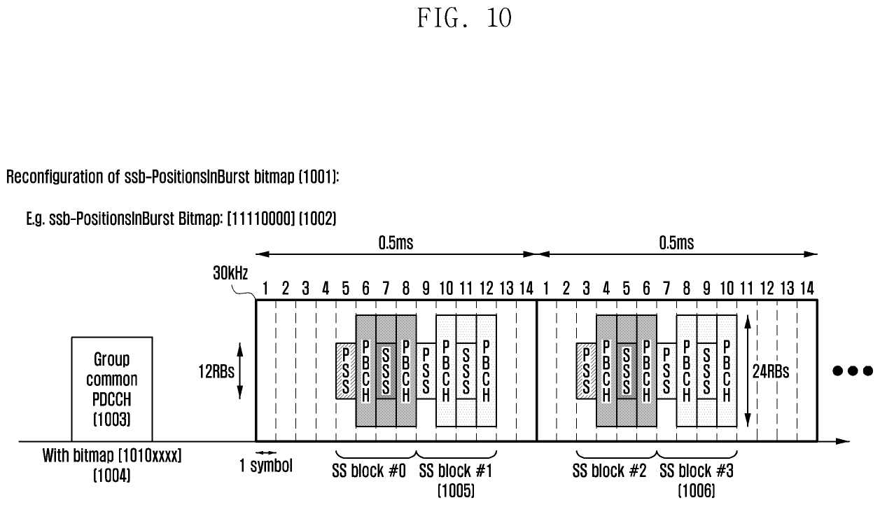

FIG. 10 illustrates a method of reconfiguring SSB transmission based on dynamic signaling of a wireless communication system according to an embodiment.

Referring to FIG. 10, a UE may be configured with ssb-PositionsInBurst=“11110000” 1002 from a BS based on higher layer signaling (SIB1 or ServingCellConfigCommon). A maximum of two SSBs at a subcarrier spacing of 30 kHz may be transmitted within 0.5 ms (or corresponding to a length of one slot when one slot includes 14 OFDM symbols), and accordingly, the UE may receive four SSBs within 1 ms (or corresponding to a length of two slots when one slot includes 14 OFDM symbols). In this case, to reduce SSB transmission density to save energy, the BS may broadcast a bitmap ‘1010xxxx’ 1004 based on group common DCI 1003 having a network energy saving-radio network temporary identifier) (nwes-RNTI) (or es-RNTI), thereby reconfiguring SSB transmission configuration information. In this case, transmission of SSB #1 1005 and SSB #3 1006 may be canceled based on a bitmap 1004 configured based on Group/Cell common DCI. FIG. 10 illustrates a method of reconfiguring SSB transmission based on bitmap-based group/cell common DCI (1001).

Based on the group/cell common DCI, the BS may reconfigure ssb-periodicity configured based on higher layer signaling. In addition, by additionally configuring timer information for indication of a time point to apply the group/cell common DCI, SSB transmission may be performed according to SSB transmission information reconfigured through the group/cell common DCI during the configured timer. Thereafter, if the timer expires, the BS may operate according to the SSB transmission information configured based on existing higher layer signaling. Accordingly, the BS may change a configuration from a normal mode to an energy saving mode based on the timer, and may reconfigure SSB configuration information caused thereby. As another method, the BS may configure, as offset and duration information for the UE, a period and a time point to apply the SSB configuration information reconfigured based on the group/cell common DCI. In this case, the UE may not monitor the SSB for a duration from the moment of receiving the group/cell common DCI to a time point of applying the offset.

Hereinafter, a description will be provided for a method of BWP or BW adaptation based on dynamic signaling for energy reduction of a base station in the 5G system.

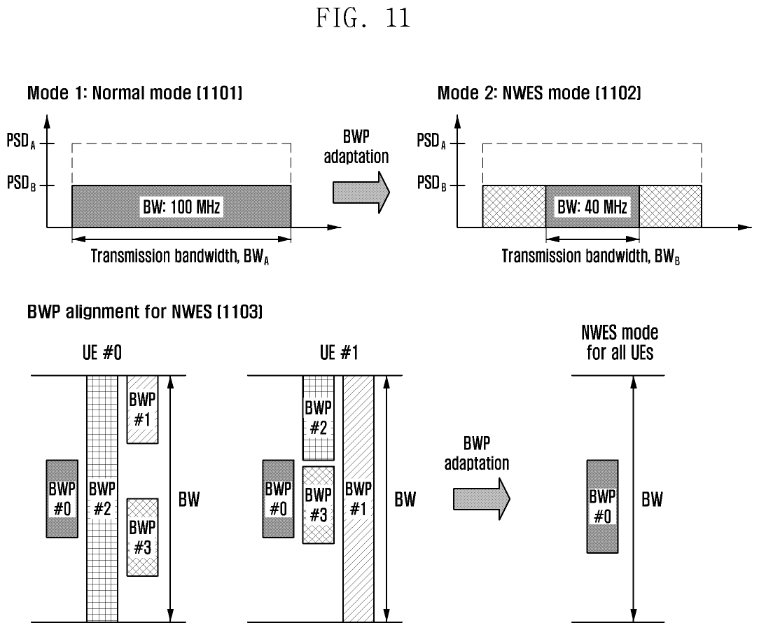

FIG. 11 illustrates a method of reconfiguring a BWP and a BW based on dynamic signaling of a wireless communication system according to an embodiment.

Referring to FIG. 11, a UE may operate using a BWP or BW activated based on higher layer signaling and L1 signaling from a BS (1101). For example, the UE may operate via a full BW of 100 MHz with a fixed power. In this case, for energy saving, the BS may adjust the BW and BWP to activate, for the UE, a narrower BW of 40 MHz with the same power (1102). In this case, adjusting the BW or BWP for energy saving by the BS may be performed to equally match the UE-specifically configured BWP and BW based on group common DCI and cell-specific DCI (1103). For example, UE #0 and UE #1 may have different BWP configurations and positions. In this case, in order for the BS to save energy by reducing BWs used, BWs and BWPs of all UEs may be configured equally to one. In this case, one or more BWPs or BWs in the operation for energy saving may be configured, which may be used to configure a UE group-specific BWP.

Herein, upper layer signaling corresponds to at least one signaling among the following signaling, or a combination of one or more thereof.
MIB
SIB or SIB X (X=1, 2, . . . )
Radio resource control (RRC)
Medium access control (MAC) control element (CE)

L1 signaling corresponds to at least one signaling method among signaling methods using the following physical layer channels or signaling, or a combination of one or more thereof.
PDCCH
DCI
UE-specific DCI
Group common DCI
Common DCI
Scheduling DCI (for example, DCI used for scheduling DL or UL data)
Non-scheduling DCI (for example, DCI not used for scheduling DL or UL data)
PUCCH
UL control information (UCI)

Hereinafter, the above examples may be described through several embodiments, but they are not independent of each other, and one or more embodiments may be applied simultaneously or in combination.

Hereinafter, a description will be provided for a DRX alignment method based on dynamic signaling to save BS energy in the 5G system.

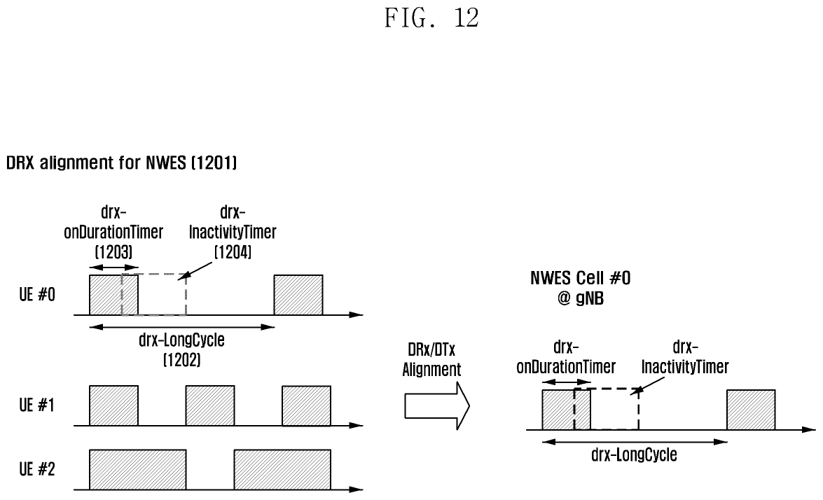

FIG. 12 illustrates a method of reconfiguring DRX based on dynamic signaling of a wireless communication system according to an embodiment.

Referring to FIG. 12, a BS may UE-specifically configure DRX based on higher layer signaling. For example, different drx-LongCycle 1202, drx-ShortCycle, drx-onDurationTimer 1203, and drx-InactivityTimer 1204 may be configured for each UE. Thereafter, for energy saving, the BS may configure the UE-specific DRX configuration to be UE group-specific or cell-specific based on layer 1 (L1) signaling (1201). Accordingly, the BS may achieve, for energy saving, the same effect as that of power saving based on DRX by the UE.

Hereinafter, a description will be provided for a discontinuous transmission (DTx) operation for reducing energy consumption of a BS in the 5G system.

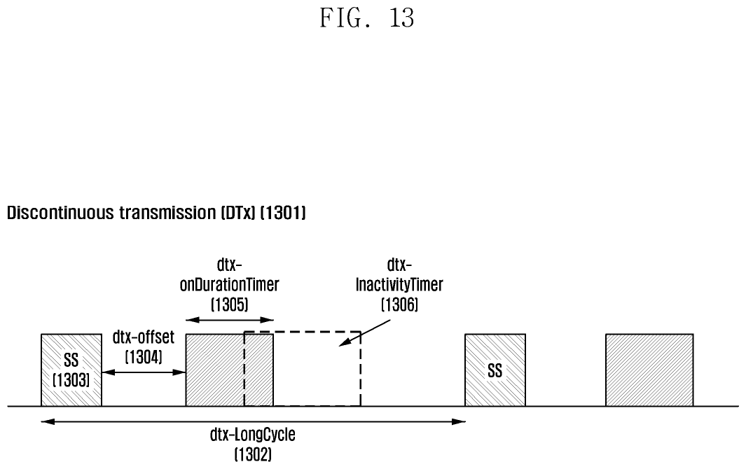

FIG. 13 illustrates a DTx method for BS energy saving according to an embodiment.

Referring to FIG. 13, the gNB may configure a discontinuous transmission (DTx) for energy saving through higher layer signaling (e.g., new SIB for DTx or RRC signaling) and L1 signaling (e.g., DCI). In this case, the BS may configure dtx-onDurationTimer 1305 for transmitting a PDCCH for scheduling of a DL SCH for DTx operation or a reference signal for measurement for RRM measurement, beam management, pathloss, etc., a synchronization signal (SS) 1303 configuration information for synchronization before dtx-onDuration Timer and dtx-InactivityTimer 1306 for receiving a PDSCH after reception of the PDCCH for scheduling of the DL SCH, dtx-offset 1304 for configuring an offset between dtx-onDurationTimer after the SS, and dtx-(Long) Cycle 1302 for DTx to operate periodically based on the configuration information. In this case, dtx-cycle may be configured as multiple dtx-cycles including a long cycle and a short cycle. During the DTx operation, the BS may consider a transmission node to be off (or inactive) and therefore, the BS may not transmit DL control channel (CCH), shared channel (SCH), and DL RS. That is, during the DTx operation, the BS may transmit a DL channel only during SS, dtx-onDurationTimer, and dtx-InactivityTimer. In this case, SS-gapbetweenBurst (gap between SS bursts in time domain) or the number of SS bursts may be additionally configured as additional information of the configured SS.

Hereinafter, a description will be provided for a method of activating a BS based on a gNB wake-up signal (WUS) during a deactivation mode of the BS in order to reduce energy consumption of the BS in the 5G system.

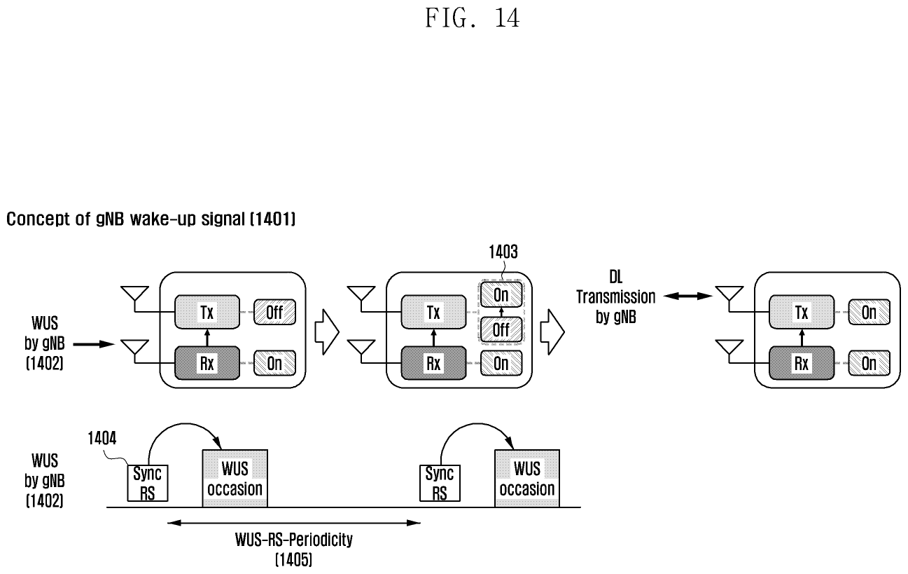

FIG. 14 illustrates a BS operation according to a gNB WUS according to an embodiment.

Referring to FIG. 14, a BS may maintain a transmitter node in an off (or inactive) state while the BS is in an inactive state (or sleep mode) to save energy. The BS may then receive a gNB WUS 1402 from a UE to activate the sleep mode of the BS. Thereafter, the BS may change the Tx node to be an on (or active) state when receiving the WUS from the UE based on an Rx node (Operation 1403). The BS may then perform DL transmission to the UE. In this case, the BS may perform synchronization after Tx on, and perform control channel and data channel transmission. In addition, various UL signals, such as PRACH, scheduling request (SR PUCCH), and PUCCH including Ack, may be considered as the gNB WUS. Based on the method above, the BS may perform energy saving, and at the same time, the UE may improve latency.

In this case, the BS may configure a WUS occasion for receiving a gNB WUS, and a Sync RS for synchronization before the UE transmits a gNB WUS. As the sync RS, an SSB, a TRS, a light SSB (PSS+SSS), consecutive SSBs or new RS (continuous PSS+SSS) may be considered, and as the WUS, a PRACH, a PUCCH with SR, or a sequence-based signal may be considered. A Sync RS 1404 for the UE to activate a deactivation mode for energy saving of the BS, and a WUS occasion for receiving a WUS may be repeatedly transmitted in a WUS-RS periodicity 1405. Although, in FIG. 14, 1-to-1 mapping between the sync RS and WUS occasion is described by way of an example, the disclosure is not limited thereto. For example, the sync RS and WUS occasion may have N-to-1 mapping, 1-to-N mapping, or N-to-M mapping.

The following provides for a method of dynamically turning on/off spatial domain elements (i.e., antenna, power amplifier (PA), or transceiver units or transmission radio units (TxRUs)) of a BS to save BS energy in the 5G system.

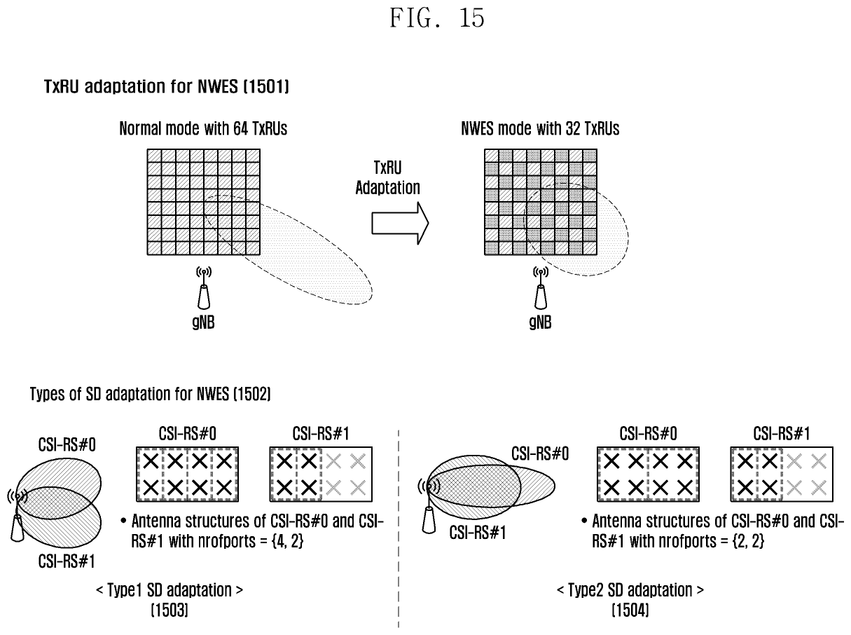

FIG. 15 illustrates an antenna adaptation method of a BS to save energy in a wireless communication system according to an embodiment.

Referring to FIG. 15, a BS may adjust a Tx antenna port per radio unit (RU) for energy saving (network energy savings (NWES) or NES) (1501). For example, since energy consumed in a PA of the BS accounts for most of energy consumption of the BS, the BS may turn off a Tx antenna to save energy. In this case, to determine whether it is possible to turn off the Tx antenna, the BS may refer/use the reference signal received power (RSRP), channel quality indicator (CQI), reference signal received quality (RSRQ), and the like, of a UE. The BS may perform Tx transmission by adjusting the number of activated Tx antennas for each UE group or UE. In this case, the BS may configure, for the UE, beam information according to on/off of the antenna or information including at least one reference signal information (e.g., at least one of a CSI resource, a CSI-RS resource set, or a CSI report) based on higher layer signaling (RRC signaling) or DCI signaling. The BS may configure different antenna information for each BWP, and thus may reconfigure the antenna information according to a BWP change. The BS may receive CSI feedback from the UE to determine whether spatial domain (SD) adaptation is possible. The BS may determine SD adaptation (based on the CSI feedback). The BS may receive, from the UE, multiple feedbacks based on antenna structure hypotheses of various antenna patterns for SD adaptation.

More specifically, the BS may apply multiple types (e.g., two types) of SD adaptation for energy saving (1502). For example, the multiple types may include Type 1 SD adaptation 1503 and Type 2 SD adaptation 1504.

If Type 1 SD adaptation 1503 is applied, the BS may adapt the number of antenna ports while maintaining the number of physical antenna elements for each antenna port (i.e., a logical port). In this case, RF characteristics (e.g., tx power and beam) per port may be the same. Therefore, the UE may perform measurement by combining CSI-RSs of the same port during CSI measurement (e.g., layer 1 (L1)-RSRP, layer 3 (L3)-RSRP, and the like).

In another method, when Type 2 SD adaptation 1504 is applied, the BS may turn on/off a physical antenna element for each port by maintaining the same number of antenna ports (i.e., logical ports). In this case, the RF characteristics per port may differ. The UE may distinguish between CSI-RSs of the same port and perform measurements for each of the CSI-RSs during CSI measurement. The BS may save energy by using one or more of multiple types of SD adaptation methods including the two types of SD adaptation methods mentioned above.

Hereinafter, an on-demand SSB and SIB1 configuration method for application of on-demand SSB and SIB for energy saving of a base station in the 5G system is described. Herein, on-demand operation may refer to including on-demand SSB and on-demand SIB (e.g., on-demand SIB1). Furthermore, while embodiments are described below with an emphasis on on-demand SIB1, the disclosure is of course applicable to on-demand SSB and another SIB (on-demand SIB). Unless mentioned otherwise, an SIB1 request may be made based on a WUS or by means of a WUS, and the corresponding WUS may be understood as a WUS for the SIB1 request.

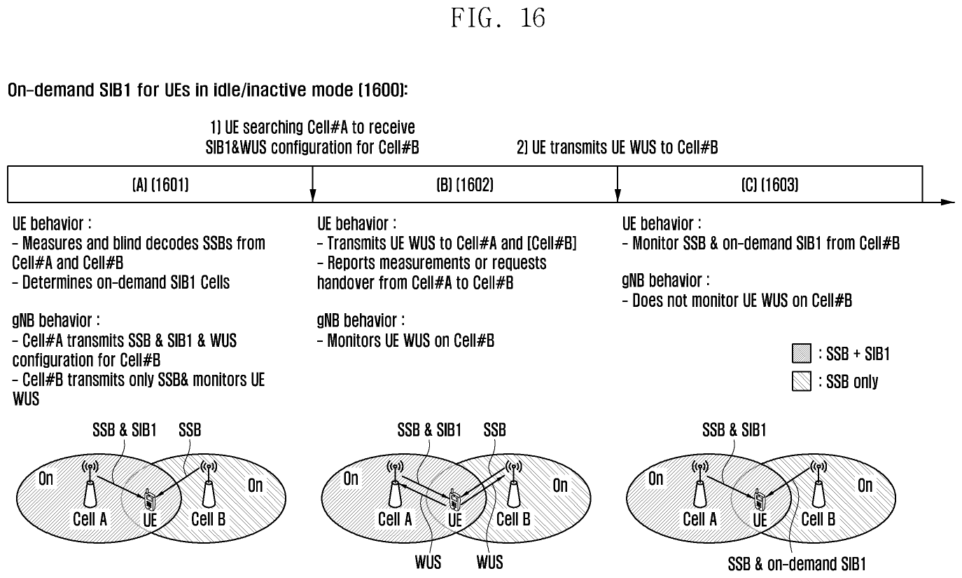

FIG. 16 illustrates on-demand SIB1 operation of a BS and a UE considering multiple cells according to an embodiment.

A BS may apply/configure/operate multiple cells with different functions for on-demand SIB1 operation considering multiple cells. For example, the BS may apply/configure/operate two different cells with different functions for on-demand SIB1 operation considering multiple cells.

For example, the BS may periodically transmit additional information (e.g., WUS configuration, SIB information of additional neighboring cells) to (or from) the anchor (or reference, adjacent, neighbor) cell for the on-demand SIB1 operation of neighboring cells, and may provide the UE with information of cells that do not transmit SIB1 during the on-demand SIB1 operation (cells that do not transmit SIB1, cells that do not perform SIB1 transmission). A cell that does not transmit SIB1 during the on-demand SIB1 operation may be an on-demand SIB1 cell or may include an on-demand SIB1 cell.

Then, the BS may apply/configure/operate an on-demand SIB1 cell. The on-demand SIB1 cell is a cell that does not transmit SIB1 to save energy. For example, whether or not to transmit SIB1 of an on-demand SIB1 cell may be based on the request of the UE (i.e., on-demand), and the on-demand SIB1 cell does not transmit SIB1 when there is no request from the UE, and transmits SIB1 when the UE requests it. The on-demand SIB1 cell is always transmitting SSB (i.e., regardless of the UE's request) and may monitor WUS according to its configuration. Whether the BS monitors WUS may be configured for the UE through the anchor cell based on higher layer signaling. When the BS does not (directly) receive the WUS from the on-demand SIB1 cell, the BS may receive the SIB1 request from the anchor cell (or forward the SIB1 request to the on-demand SIB1 cell) based on backhaul signaling. The on-demand SIB1 operation may be performed using the above two cells. In this case, the anchor cell may support one or multiple on-demand SIB1 cells and may have greater coverage than the on-demand SIB1 cells.

Referring to FIG. 16, the BS may apply on-demand SIB1 operation to save energy. More specifically, referring to section (A) 1601, the BS may perform an on-demand SIB1 operation using multiple cells (an anchor cell (Cell A) and an on-demand SIB1 cell (Cell B)). In this case, the BS may transmit, via the anchor cell (Cell A), the SSB and SIB1 of the corresponding cell and additionally transmit the WUS configuration (resource configuration and power control information for WUS transmission) and some SIB1 information (some of the information included in the SIB1 of the on-demand SIB1 cell, for example, information related to Access (e.g., AccessCellInfo or Barring information)) to request the SIB1 of the on-demand SIB1 cell. Additionally/alternatively, the BS may transmit SSB from the on-demand SIB1 cell (Cell B) and monitor the WUS according to the WUS configuration. In this case, the UE may measure the SSB from Cell A and Cell B and determine whether to request SIB1 from Cell B when packet processing is required.

As a method in which a UE distinguishes between an anchor cell and an on-demand SIB1 cell, one of the following methods or one or more combinations thereof may be employed. The BS may indicate the anchor cell or on-demand AIB1 cell by applying one or more of the following methods.

### Method 1

The UE may determine the anchor cell or the on-demand SIB1 cell through the PSS, SSS, and/or PCI of the SSB. More specifically, the PCI is determined in Equation (2) as follows.

$${N}_{I D}^{cell} = 3 {N}_{I D}^{( 1 )} + {N}_{I D}^{( 2 )} {N}_{I D}^{( 1 )} ∈ \{ 0 , 1 , … , 335 \} , {N}_{I D}^{( 2 )} ∈ \{ 0 , 1 , 2 \} \qquad ( 2 )$$

In Equation (2), the ranges of

$${N}_{ID}^{( 1 )} and {N}_{ID}^{( 2 )}$$

are examples, and the range of possible values for

$${N}_{ID}^{( 1 )} and {N}_{ID}^{( 2 )}$$

in the disclosure is not limited thereto.

$${N}_{ID}^{c e l l}$$

may be 0, . . . , 1007, but these values are example and the range of possible values for N_{ID}^{cell} is not limited thereto. In case that cell IDS

$${N}_{ID}^{( 2 )}$$

of the PSS and/or cell group ID

$${N}_{ID}^{( 1 )}$$

of the SSS are configured as a pre-configured or determined values, the UE may determine that the corresponding cell is the anchor cell or on-demand SIB1 cell. For example, at least some of the possible values for

$${N}_{ID}^{( 2 )}$$

and/or at least some of the possible values for

$${N}_{ID}^{( 1 )}$$

may be configured/determined to indicate that it is an anchor cell. Additionally/alternatively, at least some of the possible values for

$${N}_{ID}^{( 2 )}$$

and/or at least some of the possible values for

$${N}_{ID}^{( 1 )}$$

may be configured/determined to indicate that it is an on-demand SIB1 cell.

Additionally/alternatively, in case that the PCI determined through the PSS and SSS is configured as a specific pre-configured or determined value, the UE may determine that the corresponding cell is the anchor cell or on-demand SIB1 cell. For example, at least some of the possible values for

$${N}_{ID}^{cell}$$

may be configured/determined to indicate that it is the anchor cell. For example, at least some of the possible values for

$${N}_{ID}^{cell}$$

may be configured/determined to indicate that it is the on-demand SIB1 cell.

### Method 2

The UE may determine that the cell is an anchor cell or an on-demand SIB1 cell by using information of the MIB through the PBCH of the SSB. More specifically, the UE may determine the anchor cell or on-demand SIB1 cell by using at least some of the information of the MIB in Table 13 below.

```
TABLE 13
MIB ::= SEQUENCE {
  systemFrameNumber BIT STRING (SIZE (6)),
  subCarrierSpacingCommon ENUMERATED {scs15or60, scs30or120},
  ssb-SubcarrierOffset INTEGER (0..15),
  dmrs-TypeA-Position ENUMERATED {pos2, pos3},
  pdcch-ConfigSIB1,
  cellBarred ENUMERATED {barred, notBarred},
  intraFreqReselection ENUMERATED {allowed, notAllowed},
  spare BIT STRING (SIZE (1))
}
```

If the spare information is configured as “0”, the cell corresponding to the corresponding MIB may be determined to be an anchor cell, and when the spare information is configured as “1”, the cell corresponding to the corresponding MIB may be determined to be an on-demand SIB1 cell. Conversely, if the spare information is configured as “1”, the cell corresponding to the corresponding MIB may be determined to be an anchor cell, and when the spare information is configured as “0”, the cell corresponding to the corresponding MIB may be determined to be an on-demand SIB1 cell.

Additionally/alternatively, the ssb-SubcarrierOffset and/or pdcch-ConfigSIB1 information of the MIB may be utilized. In this case, the ssb-SubcarrierOffset and/or pdcch-ConfigSIB1 information of the MIB may be interpreted and used differently from the conventional information. For example, a specific most significant bit (MSB) or least significant bit (LSB) may indicate whether the cell is an on-demand SIB1 cell.

For example, the MSB or LSB of ssb-SubcarrierOffset and/or pdcch-ConfigSIB1 may indicate whether the cell corresponding to the MIB is an on-demand SIB1 cell. The ssb-SubcarrierOffset and/or pdcch-ConfigSIB1 are examples, and information elements (IEs) in other MIBs may be used. For example, the MSB or LSB of an IE in a specific MIB may indicate whether the cell corresponding to the MIB is an on-demand SIB1 cell. For example, when the MSB or LSB has a predefined/configured value, the cell corresponding to the corresponding MIB may be determined to be an on-demand SIB1 cell.

### Method 3

The UE may determine an on-demand SIB1 cell, based on whether SIB1 is transmitted from the corresponding cell during a specific period of time. That is, based on whether or not the SIB1 has been received from a specific cell during a specific period of time, it may be determined whether the corresponding specific cell is an on-demand SIB1 cell.

More specifically, the UE may receive in advance a configuration of a window for monitoring SIB1. The UE may determine that the at least one cell corresponding to the corresponding SIB1 is an on-demand SIB1 cell when no SIB1 is received during the corresponding period of time. For example, the UE may determine that the at least one cell corresponding to the SIB1 is an on-demand SIB1 cell when a PDSCH for the SIB1 is not received during the corresponding period of time.

Additionally/alternatively, the UE may determine an on-demand SIB1 cell, based on the number of times of search space monitoring (e.g., the number of times the UE has performed monitoring for the search space (within the window)) for receiving a PDCCH (e.g., a PDCCH addressed by a system information radio network temporary identifier (SI-RNTI)) for SIB1 scheduling (i.e., containing scheduling information of the SIB1). For example, if the number of search space monitoring is greater than or equal to a preconfigured/predefined threshold, the cell may be determined to be an on-demand SIB1 cell.

In this case, the measurement taken by the UE from the SSB of the corresponding cell should satisfy the requirement for radio resource management (RRM) measurement. This may be a requirement to access the corresponding cell. That is, if a specific cell satisfies the requirement but no SIB1 is received from the specific cell, the specific cell may be determined to be an on-demand SIB1 cell. For example, a specific cell may be determined to be an on-demand SIB1 cell when the RSRP and/or RSRQ measured from the SSB of the specific cell satisfies the RRM requirement, but no SIB1 is received from the specific cell.

Using at least one of the above methods, the UE may determine whether the corresponding cell is an on-demand SIB1 cell or an anchor cell. Using at least one of the above methods, the UE may determine whether the corresponding cell is an on-demand SIB1 cell or an anchor cell.

Thereafter, in section (B) 1602, the UE may, via the anchor cell, receive configuration information for WUS transmission based on higher layer signaling (e.g., RRC, SIB1, or SIB for network energy saving (NES)) or L1 signaling (message 4 (MSG4) or PUSCH/PUCH) and information for accessing the corresponding on-demand SIB1 cell, and may request the SIB1 to access the on-demand SIB1 cell.

In this case, the UE may determine to access the on-demand SIB1 cell rather than the anchor cell when the differences between the RSRPs and RSRQs measured from the SSBs of the anchor cell and the on-demand SIB1 cell, respectively are greater than a specific threshold. For example, when the difference between the RSRP or RSRQ measured from the SSB of the on-demand SIB1 cell and the RSRP or RSRQ measured from the SSB of the anchor cell is greater than or equal to a predefined/configured threshold, the UE may determine to access the on-demand SIB1 cell. In addition, the UE may report the measurement result to the anchor cell or request a handover, thereby indicating a request for the on-demand SIB1 cell via the anchor cell. The anchor cell may indicate, to the on-demand SIB1 cell based on backhaul signaling, the measurement result from the UE and/or whether to request the on-demand SIB1 request.

Additionally/alternatively, if access to the anchor cell is identified as not possible according to the cellBarred information of the MIB of the anchor cell, the UE may determine to access the on-demand SIB1 cell.

Thereafter, in section (B) 1602, the UE may transmit the WUS to the anchor cell or the on-demand SIB1 cell according to the WUS configuration information. For example, the WUS may be transmitted via PUCH, PRACH, or PUSCH.

The UE may transmit the WUS once, or repeatedly transmit in section (C) 1603. After transmitting the WUS, the UE may monitor the PDCCH for SIB1 scheduling from the on-demand SIB1 cell. When the UE has identified the on-demand SIB1 cell in the previous section (B) 1602, the UE may not monitor the PDCCH related to SIB1 (from the on-demand SIB1 cell) until the WUS is transmitted. In this case, the BS may transmit the SIB1 without monitoring the WUS after receiving the WUS. In other words, the BS may stop monitoring the WUS after receiving the WUS and transmit the SIB1 of the on-demand SIB1 cell.

A BS and a UE may perform an on-demand SIB1 operation considering multiple cells by using at least some of the above methods.

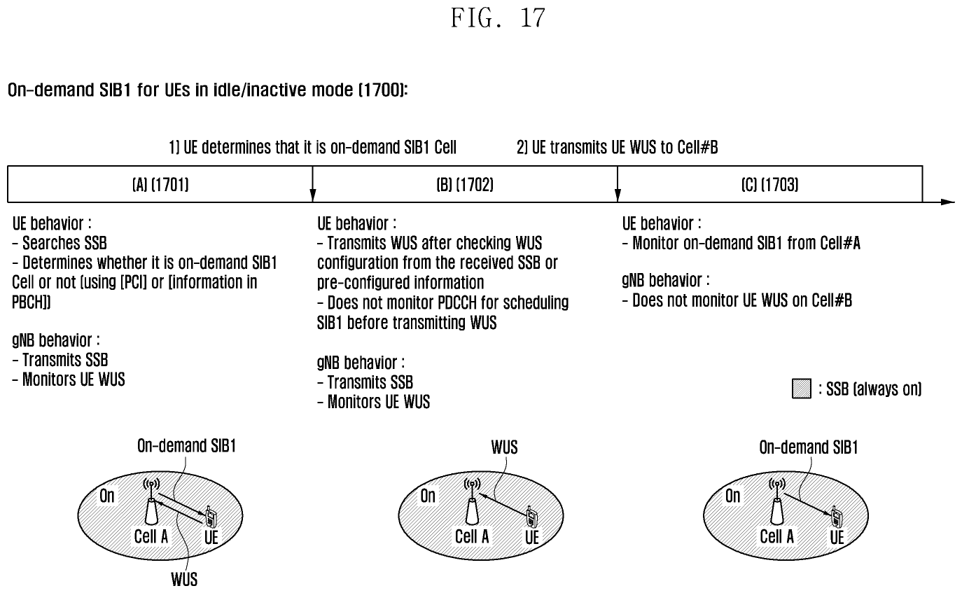

FIG. 17 illustrates an on-demand SIB1 operation of a BS and a UE considering a single cell according to an embodiment.

Referring to FIG. 17, the BS may perform on-demand SIB1 operation considering a single cell. In this case, the corresponding cell periodically transmits an SSB, and may not periodically transmit a PDCCH for SIB1 and a PDSCH for SIB1 (A) (1701). For example, whether the corresponding cell transmits SIB1 may depend on a request from the UE. The corresponding cell does not transmit SIB1 if there is no request from the UE, and may transmit SIB1 if there is a request from the UE. In addition, the cell may monitor the WUS to receive the on-demand request of SIB1. In this case, the UE may receive the SSB through the cell, and then may determine whether to perform the on-demand SIB1 operation by using one or a combination of one or more of the following methods. That is, the UE may determine whether the corresponding cell is an on-demand SIB1 cell by using one or a combination of one or more of the following methods. The BS may indicate whether the corresponding cell is an on-demand SIB1 cell by using one or a combination of one or more of the following methods.

### Method 1

The UE may determine the on-demand SIB1 cell through the PSS, SSS, or PCI of the SSB. More specifically, the PCI is determined in Equation (3) as follows.

$${N}_{ID}^{cell} = 3 {N}_{ID}^{( 1 )} + {N}_{ID}^{( 2 )} {N}_{ID}^{( 1 )} ∈ \{ 0 , 1 , … , 335 \} , {N}_{I D}^{( 2 )} ∈ \{ 0 , 1 , 2 \} \qquad ( 3 )$$

In Equation (3), the ranges of

$${N}_{ID}^{( 1 )} and {N}_{ID}^{( 2 )}$$

are examples, and the range of possible values for

$${N}_{ID}^{( 1 )} and {N}_{ID}^{( 2 )}$$

and in the disclosure is not limited thereto.

$${N}_{ID}^{cell}$$

may be 0, . . . , 1007, but these values are example and the range of possible values for N_{ID}^{cell} is not limited thereto.

In case that cell IDs

$${N}_{ID}^{( 2 )}$$

of the PSS and/or cell group ID

$${N}_{ID}^{( 1 )}$$

of the SSS are configured as a pre-configured or determined values, the UE may determine that the corresponding cell is an on-demand SIB1 cell. For example, at least some of the possible values for

$${N}_{ID}^{( 2 )}$$

and/or at least some of the possible values for

$${N}_{ID}^{( 1 )}$$

may be configured/determined to indicate that it is the on-demand SIB1 cell.

Additionally/alternatively, if the PCI determined through the PSS and SSS is configured as a specific pre-configured or determined value, the UE may determine that the corresponding cell is the on-demand SIB1 cell. For example, at least some of the possible values for

$${N}_{ID}^{cell}$$

may be configured/determined to indicate that it is the on-demand SIB1 cell.

### Method 2

The UE may determine the corresponding cell as an on-demand SIB1 cell through information of the MIB via the PBCH of the SSB. More specifically, the UE may determine the on-demand SIB1 cell by using at least some of the information of the MIB in Table 14 below.

```
TABLE 14
MIB ::= SEQUENCE {
  systemFrameNumber BIT STRING (SIZE (6)),
  subCarrierSpacingCommon ENUMERATED {scs15or60, scs30or120},
  ssb-SubcarrierOffset INTEGER (0..15),
  dmrs-TypeA-Position ENUMERATED {pos2, pos3},
  pdcch-ConfigSIB1,
  cellBarred ENUMERATED {barred, notBarred},
  intraFreqReselection ENUMERATED {allowed, notAllowed},
  spare BIT STRING (SIZE (1))
}
```

For example, the spare information may be used. If the spare information is configured as “0”, the on-demand SIB1 operation for the cell corresponding to the corresponding MIB may be determined to be deactivated, and when it is configured as “1”, the cell corresponding to the corresponding MIB may be determined to be an on-demand SIB1 cell. Conversely, if the spare information is configured as “1”, the on-demand SIB1 operation for the cell corresponding to the corresponding MIB may be determined to be deactivated, and when the spare information is configured as “0”, the cell corresponding to the corresponding MIB may be determined to be an on-demand SIB1 cell.

Additionally/alternatively, the ssb-SubcarrierOffset and/or pdcch-ConfigSIB1 information of the MIB may be used. In this case, the ssb-SubcarrierOffset and/or pdcch-ConfigSIB1 information of the MIB may be interpreted and used differently from the conventional information. For example, a specific MSB or LSB may indicate whether the cell is an on-demand SIB1 cell.

For example, the MSB or LSB of ssb-SubcarrierOffset and/or pdcch-ConfigSIB1 may indicate that the cell corresponding to the corresponding MIB is the on-demand SIB1 cell. The ssb-SubcarrierOffset and/or pdcch-ConfigSIB1 are examples, and IEs in other MIBs may be used. For example, the MSB or LSB of an IE within a specific MIB may indicate that the cell corresponding to the MIB is an on-demand SIB1 cell. For example, if the MSB or LSB has a predefined/configured value, the cell corresponding to the corresponding MIB may be determined to be an on-demand SIB1 cell.

### Method 3

The UE may determine an on-demand SIB1 cell, depending on whether SIB1 is transmitted from the corresponding cell during a specific period of time. In other words, depending on whether the SIB1 has been received from a specific cell during a specific period of time, it may be determined whether the corresponding specific cell is an on-demand SIB1 cell.

More specifically, the UE may receive in advance a configuration of a window for monitoring SIB1. The UE may determine that the at least one cell corresponding to the corresponding SIB1 is an on-demand SIB1 cell in case that no SIB1 is received during the corresponding period of time. For example, the UE may determine that the at least one cell corresponding to the SIB1 is an on-demand SIB1 cell in case that a PDSCH for the SIB1 is not received during the corresponding period of time.

The UE may determine an on-demand SIB1 cell, based on the number of times of search space monitoring (e.g., the number of times the UE has performed monitoring for the search space (within the window)) for receiving a PDCCH (e.g., a PDCCH addressed by a system information radio network temporary identifier (SI-RNTI)) for SIB1 scheduling (i.e., containing scheduling information of the SIB1). For example, when the number of search space monitoring is greater than or equal to a preconfigured/predefined threshold, the cell may be determined to be an on-demand SIB1 cell.

In this case, the measurement taken by the UE from the SSB of the corresponding cell should satisfy the requirement for radio resource management (RRM) measurement. This may be a requirement to access the corresponding cell. In other words, when a specific cell satisfies the requirement but no SIB1 is received from the specific cell, the specific cell may be determined to be an on-demand SIB1 cell. For example, a specific cell may be determined to be an on-demand SIB1 cell when the RSRP and/or RSRQ measured from the SSB of the specific cell satisfies the RRM requirement, but no SIB1 is received from the specific cell.

Using at least one of the above methods, the UE may determine whether the corresponding cell activates or deactivates the on-demand SIB1. Using at least one of the above methods, the BS may determine whether the corresponding cell is an on-demand SIB1 cell or an anchor cell.

Thereafter, in section (B) 1702, the UE determines whether the on-demand SIB1 of the corresponding cell is activated. If it is activated, the UE may request the SIB1 by transmitting a WUS based on the pre-configured WUS resource information to transmit the WUS when access is required. The UE may determine the resource of the corresponding WUS transmission by applying a pre-configured/pre-fixed time/frequency offset with respect to the SSB. The pre-configured/pre-fixed offset may be pre-configured differently for each PCI. As an alternative method, the UE may reinterpret the MIB information of the SSB with respect to the on-demand SIB1 cell to determine the resource location for WUS transmission. For example, a specific frequency domain resource allocation (FDRA) and TDRA list table may be pre-configured for WUS resource allocation and determined by being indicated based on pdcch-ConfigSIB1 in the MIB. The FDRAs and/or TDRAs within the preconfigured FDRA list table and/or TDRA list table may be indicated by pdcch-ConfigSIB1 of the MIB. The MSB 4 bits of pdcch-ConfigSIB1 may indicate FDRA information, and the LSB 4 bits may indicate TDRA information. Alternatively, the MSB 4 bits of pdcch-ConfigSIB1 may indicate TDRA information, and the LSB 4 bits may indicate FDRA information.

In section (C) 1703 after performing the WUS transmission based on the configuration information of the UE, the UE may monitor the PDCCH for scheduling of SIB1 from the corresponding cell, and may initially access the corresponding cell after receiving the SIB1. The BS may not monitor the WUS from the corresponding cell after receiving the WUS. In other words, the BS may stop monitoring the WUS from the corresponding cell after receiving the WUS.

Hereinafter, descriptions are provided for a UE operation and method for distinguishing an on-demand SIB1 cell according to an embodiment of the disclosure. In FIG. 17, for UL WUS transmission in a NES cell where on-demand SIB1 is in operation, a UE may determine, based on one of the following methods or a combination thereof, whether a corresponding cell is a NES cell or is a normal cell enabling reception of a WUS configuration. Whether a specific cell is a NES cell or a normal cell may be indicated according to the following methods.

### Method 1

Method 1 describes a method in which a UE searches for a normal cell that transmits a WUS configuration based on a received SSB. More specifically, based on ssb-subcarrierOffset and pdcch-ConfigSIB1 of an SSB, a UE may inform, including a WUS configuration, a location of a cell performing a normal operation.

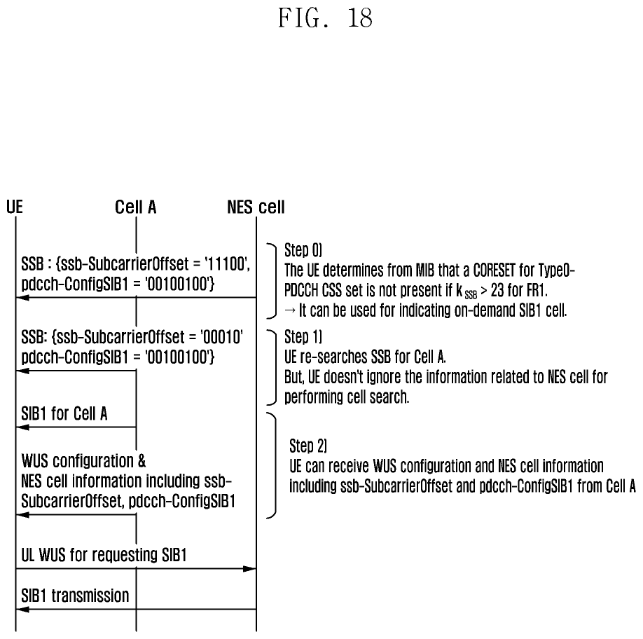

FIG. 18 illustrates a normal cell search operation based on SSB reception of an on-demand SIB1 cell according to an embodiment.

Referring to FIG. 18, a UE may detect an SSB, based on a synchronization raster. In this case, the UE may detect ssb-SubcarrierOffset and pdcch-ConfigSIB1 information based on a MIB. Afterward, according to an ssb-SubcarrierOffset k_{SSB} configuration value of the SSB transmitted in a corresponding cell, the cell may be determined to be a cell to which on-demand SIB1 is applied. For example, if a k_{SSB} value is configured to be 30 or configured to be 23 or greater for FR1, the UE may determine that there is no Type0-PDCCH common search space (CSS) for SIB1 scheduling in the cell, and may thus determine that the cell is an on-demand SIB1 cell. The disclosure is not limited thereto, and the UE may be informed about the on-demand SIB1 cell based on other MIB information, for example, a combination with cellBarred or a spare bit. Afterward, the UE may use other information of the MIB of the cell to determine a location of the cell having WUS configuration information required for UL WUS transmission to request on-demand SIB1 from the cell. For example, an offset may be determined as follows based on pdcch-ConfigSIB1 information. An index value may be determined to be N (N may be determined based on higher-layer signaling and a pre-configured scheme)*controlResourceSetZero (i.e., 4 bits MSB of pdcch-ConfigSIB1)+searchSpaceZero (i.e., 4 bits LSB of pdcch-ConfigSIB1), and an SSB location may be determined based on a global synchronization channel number (GSCN) connected to a corresponding index, or an SSB location of the cell capable of transmitting a WUS configuration may be determined based on a GSCN (or absolute radio frequency channel number (ARFCN)) offset based on a GSCN (or ARFCN) of the received SSB. Alternatively, the cell that transmits the WUS configuration may be informed based on other MIB information, for example, a combination with interFrequencyReselection, cellBarred, or a spare bit. In addition, 8 bits of pdcch-ConfigSIB1 may be used all at once to inform about the ARFCN or GSCN, and a value greater than a granularity of the offset may be configured to determine an SSB location of another frequency band. Afterward, the UE may receive the WUS configuration information and some (e.g., accessibility, RACH configuration, power control information, etc.) of SIB1 information of the on-demand SIB1 cell from the cell transmitting the WUS configuration, and may receive new ssb-SubcarrierOffset and pdcch-ConfigSIB1 for configuring CORESET0. In this case, based on new ssb-SubcarrierOffset and pdcch-ConfigSIB1 for configuring newly configured CORESET0, the UE may update previous ssb-SubcarrierOffset and pdcch-ConfigSIB1 for configuring CORESET0 of the MIB. Afterward, the UE may receive on-demand SIB1 from the on-demand SIB1 cell and perform initial access. In the cell transmitting the WUS configuration, even if the cell is barred, system information may be transmitted in order for the UE to receive the WUS configuration and on-demand SIB1 cell-related information, and the UE may receive the WUS configuration and the on-demand SIB1 cell-related information from the cell transmitting the WUS configuration. Therefore, the UE having NES capability supports the corresponding operation.

Based on Method 1, an on-demand SIB1 cell identification method may be provided based on SSB reception, so that the cell search operation of the UE may be supported more efficiently.

When the UE acquires the WUS configuration and NES cell information, the UE may determine whether to request on-demand SIB1 from a NES cell. If the UE determines to request on-demand SIB1 from the NES cell, the UE may transmit a UL WUS to the NES cell to request on-demand SIB1. Afterward, the UE may receive SIB1 from the NES cell, based on the UL WUS.

### Method 2

Method 2 provides a cell search method of transmitting an on-demand SIB1 cell and a WUS configuration by using a BS restriction.

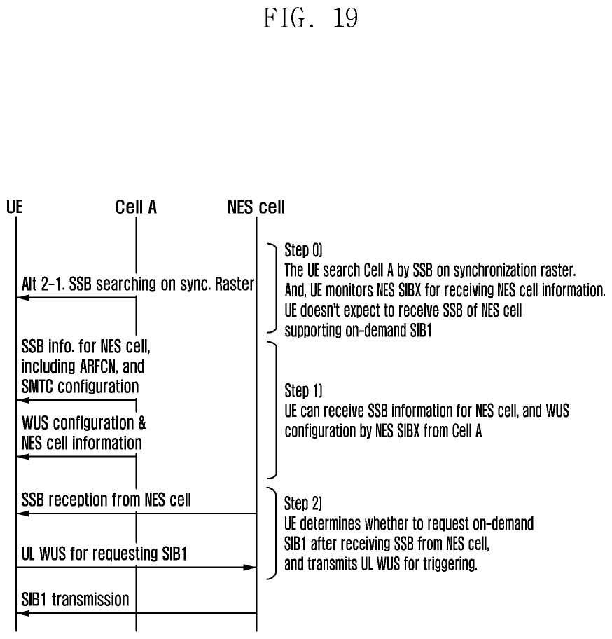

FIG. 19 illustrates an on-demand SIB1 cell operation based on multiple cells according to an embodiment.

Referring to FIG. 19, a UE may receive an SSB based on a synchronization raster. In this case, a BS cannot transmit the SSB based on the synchronization raster during an on-demand SIB1 operation, and may repeatedly perform SSB transmission on other specific resources. Afterward, when falling back to a normal operation, the BS may perform transmission on the synchronization raster. Afterward, the UE may receive ARFCN and SMTC configuration information informing about locations of SSBs of candidate on-demand SIB1 cells that include corresponding WUS configuration information. Based on the configured information, the UE may receive an SSB of an on-demand SIB1 cell, identify a channel state based on the SSB, and then determine whether to access the on-demand SIB1 cell. In this case, if a cell from which the UE has received a WUS configuration is barred, the UE may request on-demand SIB1 from a cell having the best channel state (e.g., RSRP or RSRQ) among the candidate on-demand SIB1 cells. Based on the methods, the UE may reduce unnecessary cell searches by preferentially searching for a cell that transmits the WUS configuration. In the cell transmitting the WUS configuration, even if the cell is barred, system information may be transmitted in order for the UE to receive the WUS configuration and on-demand SIB1 cell-related information, and the UE may receive the WUS configuration and the on-demand SIB1 cell-related information from the cell transmitting the WUS configuration. Therefore, the UE having NES capability supports the corresponding operation.

According to the cell search in Method 2, the UE may receive an SSB from an on-demand SIB1 cell (e.g., an NES cell). When the UE receives the SSB from the NES cell, the UE may determine whether to request on-demand SIB1. If the UE determines to request on-demand SIB1 from the NES cell, the UE may transmit a UL WUS to the NES cell to request on-demand SIB1. Afterward, the UE may receive SIB1 from the NES cell, based on the UL WUS.

### Method 3

Method 3 provides a cell search method of transmitting an on-demand SIB1 cell and a WUS configuration based on cell barring information. A UE may receive an SSB based on a synchronization raster. In this case, if cellBarred information of a MIB of the SSB is configured to be barred, the UE may consider a corresponding cell as a cell for cell selection/reselection by adding the cell to a candidate on-demand SIB1 cell list. Afterward, to receive a WUS configuration, a cell that transmits the WUS configuration may be blind decoded based on the SSB of the synchronization raster. After receiving the WUS configuration, the UE may request on-demand SIB1 via a cell having the same PCI value among the candidate on-demand SIB1 cells. Based on the method, the UE having NES capability may manage a cell list for additional cell selection/reselection. In the cell transmitting the WUS configuration, the UE, upon receiving SIB1 of the cell, may receive additional other system information based on SIB1 to receive the WUS configuration and on-demand SIB1 cell-related information, even if the cell is barred. Therefore, the UE having NES capability supports the corresponding operation.

According to the cell search in Method 3, the UE may receive an SSB from an on-demand SIB1 cell (e.g., a NES cell). When the UE receives the SSB from the NES cell, the UE may determine whether to request on-demand SIB1. If the UE determines to request on-demand SIB1 from the NES cell, the UE may transmit a UL WUS to the NES cell to request on-demand SIB1. Afterward, the UE may receive SIB1 from the NES cell, based on the UL WUS.

### Method 4

Method 4 provides a cell search method using synchronization rasters according to different functions. More specifically, a corresponding cell may transmit SSBs based on different synchronization rasters according to different purposes, such as a NES mode or a normal operation mode. For a default synchronization raster, an SSB from a cell performing a normal operation is transmitted, and for an SSB of an on-demand SIB1 cell supporting a NES function, the SSB may be transmitted based on a NES raster defined for the NES function.

According to the cell search in Method 4, the UE may receive an SSB from an on-demand SIB1 cell (e.g., a NES cell). When the UE receives the SSB from the NES cell, the UE may determine whether to request on-demand SIB1. If the UE determines to request on-demand SIB1 from the NES cell, the UE may transmit a UL WUS to the NES cell to request on-demand SIB1. Afterward, the UE may receive SIB1 from the NES cell, based on the UL WUS.

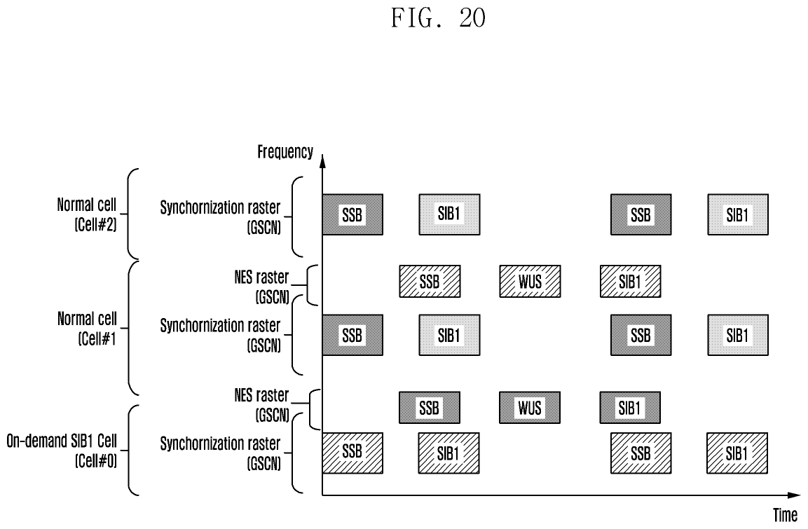

FIG. 20 illustrates a cell search method based on different rasters according to an embodiment.

Referring to FIG. 20, for a cell performing an on-demand SIB1 operation, an SSB may be transmitted based on a GSCN or ARFCN configured with a NES raster. In cells where corresponding on-demand SIB1 falls back to a normal mode, or cells performing a normal operation, an SSB may be transmitted at a GSCN of an existing synchronization raster. Therefore, the UE may support cell search by distinguishing cells supporting different functions based on different rasters according to capability of the UE. In addition, priorities of the rasters for the UE to perform blind decoding first may vary. The priority of the NES raster may be higher than that of the synchronization raster of the cell operating in a normal mode, and the priority of the synchronization raster of the cell operating in a normal mode may be higher than that of the NES raster. In addition, the UE may operate based on pre-designing of UE implementation or by considering a state of the UE, such as traffic to be processed.

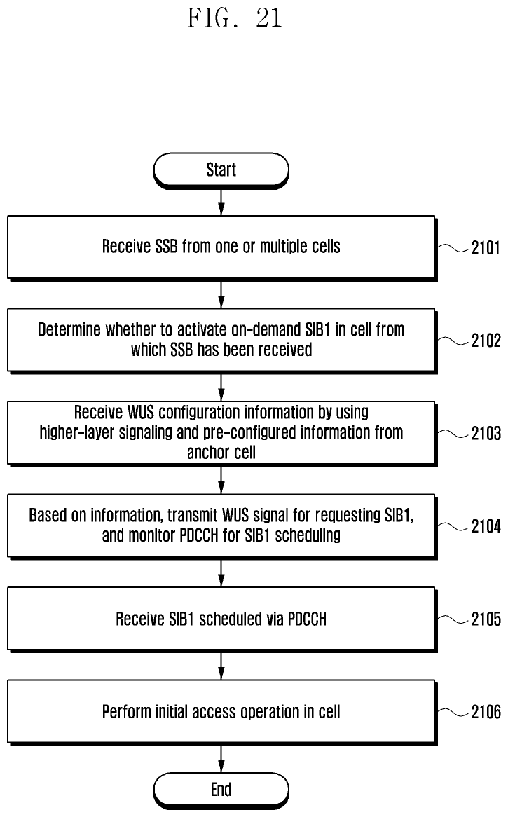

FIG. 21 is a method of a UE for applying an energy saving method in the wireless communication system according to an embodiment. Although illustrated as a series of operations, various operations of respective drawings may overlap, occur in parallel, occur in a different order, or occur multiple times. An operation may be omitted or replaced by another operation.

Based on FIG. 21, a UE operation during an on-demand operation in an SCell for energy saving by a base station is described.

Referring to FIG. 21, in step 2101, a UE may receive an SSB from a BS via one or multiple cells.

In operation 2102, the UE may determine whether to activate on-demand SIB1 in a cell from which the SSB has been received.

In operation 2103, if activation of an on-demand SIB1 operation is determined, the UE may acquire WUS configuration information. For example, the UE may receive the WUS configuration information by using higher-layer signaling and pre-configured information from an anchor cell.

For the UE operations of determining activation of the on-demand SIB operation, identifying the anchor cell and the on-demand SIB1 cell, performing cell search, etc., reference is made to various embodiments of the disclosure described above.

In operation 2104, based on the information, the UE may transmit, to the cell, a WUS signal for requesting SIB1, and monitor a PDCCH from the cell for SIB1 scheduling.

In operation 2105, the UE may identify the presence or absence of information for SIB1 scheduling via the PDCCH in the cell, and if there is information for SIB1 scheduling, the UE may receive SIB1 based on the scheduling information.

In operation 2106, the UE may perform an initial access operation in the cell. The UE may perform the initial access operation based on information included in the received SIB1.

For specific details of the UE operation according to the embodiment of the disclosure described above, reference may be made to the descriptions of the embodiment of the disclosure described above.

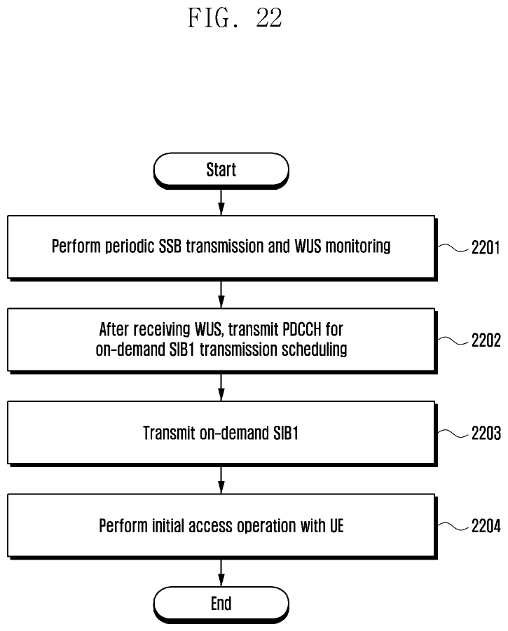

FIG. 22 is a method of a BS for applying an energy saving method in the wireless communication system according to an embodiment. Although illustrated as a series of operations, various operations of respective drawings may overlap, occur in parallel, occur in a different order, or occur multiple times. A operation may be omitted or replaced by another operation.

Referring to FIG. 22, in operation 2201, a BS may perform periodic SSB transmission to a UE, and may perform WUS monitoring.

In operation 2202, the BS may receive a WUS from an anchor cell or the UE, and then transmit a PDCCH for on-demand SIB1 transmission scheduling. DCI transmitted via the PDCCH may include scheduling information for scheduling of SIB1.

In operation 2203, the BS may transmit on-demand SIB1 to the UE. The BS may transmit on-demand SIB1, based on the scheduling information included in the DCI.

In operation 2204, the BS may then perform an initial access operation with the UE.

For specific details of the base station operation according to the embodiment of the disclosure described above, reference may be made to the descriptions of the embodiment of the disclosure described above.

Various modifications may be made to the methods illustrated in the flowcharts of this specification. For example, although illustrated as a series of operations, various operations of respective drawings may overlap, occur in parallel, occur in a different order, or occur multiple times. In another example, an operation may be omitted or replaced by another operation.

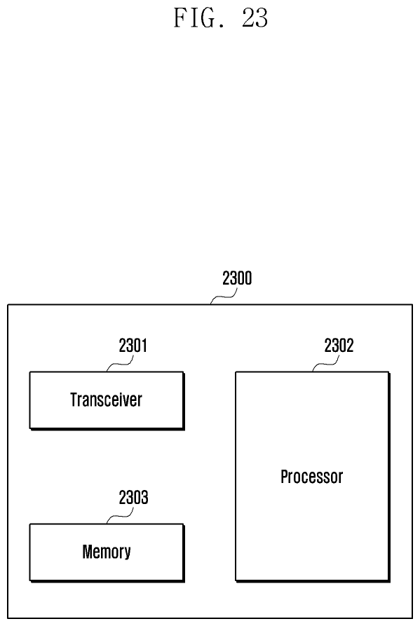

FIG. 23 is a block diagram of a UE according to an embodiment.

Referring to FIG. 23, the UE 2300 may include a transceiver 2301, a controller (e.g., processor) 2302, and a storage (e.g., memory) 2303. The transceiver 2301, the controller 2302, and the storage 2303 of the UE 2300 may be operated according to at least one or a combination of methods corresponding to the above-described embodiments. However, components of the UE 2300 are not limited to the illustrated example. The UE 2300 may include more or fewer components than the above-described components. Furthermore, the transceiver 2301, the controller 2302, and the storage 2303 may be implemented in the form of a single chip.

The transceiver 2301 may include a transmitter and a receiver. The transceiver 2301 may transmit/receive signals with the BS. The signals may include control information and data. The transceiver 2301 may include an RF transmitter configured to up-convert and amplify the frequency of transmitted signals, and an RF receiver configured to low-noise-amplify received signals and down-convert the frequency thereof. The transceiver 2301 may receive signals through a radio channel, output the same to the controller 2302, and transmit signals output from the controller 2302 through the radio channel.

The controller 2302 may control a series of processes such that the UE 2300 can operate according to the above-described embodiments of the disclosure. For example, the controller 2302 may perform or control the UE's operations for performing at least one or a combination of the methods according to embodiments of the disclosure. The controller 2302 may include at least one processor. For example, the controller 2302 may include a communication processor (CP) which performs control for communication and an application processor (AP) which controls upper layers (e.g., applications).

The storage 2303 may store control information (for example, channel estimation-related information using DMRSs transmitted in a PUSCH included in a signal acquired by the UE 2300) or data, and may have a region for storing data necessary for control of the controller 2302 and data produced during control by the controller 2302.

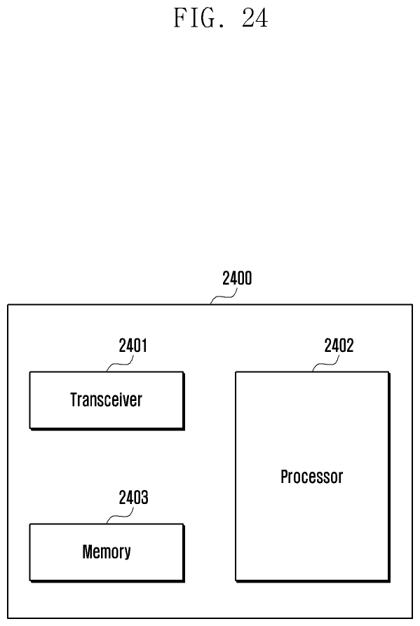

FIG. 24 is a block diagram of a BS according to an embodiment.

Referring to FIG. 24, the BS 2400 may include a transceiver 2401, a controller (e.g., processor) 2402, and a storage (e.g., memory) 2403. The transceiver 2401, the controller 2402, and the storage 2403 of the BS 2400 may operate according to at least one or a combination of methods corresponding to the above-described embodiments. However, components of the BS 2400 are not limited to the above-described example. The BS 2400 may include more or fewer components than the above-described components. Furthermore, the transceiver 2401, the controller 2402, and the storage 2403 may be implemented in the form of a single chip.

The transceiver 2401 may include a transmitter and a receiver. The transceiver 2401 may transmit/receive signals with the UE. The signals may include control information and data. The transceiver 2401 may include an RF transmitter configured to up-convert and amplify the frequency of transmitted signals, and an RF receiver configured to low-noise-amplify received signals and down-convert the frequency thereof. The transceiver 2401 may receive signals through a radio channel, output the same to the controller 2402, and transmit signals output from the controller 2402 through the radio channel.

The controller 2402 may control a series of processes such that the BS can operate according to the above-described embodiments of the disclosure. For example, the controller 2642 may perform or control the BS's operations for performing at least one or a combination of the methods according to embodiments of the disclosure. The controller 2402 may include at least one processor. For example, the controller 2402 may include a CP which performs control for communication and an AP which controls upper layers (e.g., applications).

The storage 2403 may store control information (for example, channel estimation-related information generated using DMRSs transmitted in a PUSCH determined by the BS 2400), data, and control information or data received from the UE, and may have a region for storing data necessary for control of the controller 2402 and data produced during control by the controller 2402.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a terminal in a wireless communication system, the method comprising:
receiving, from a first cell, a wake up signal (WUS) configuration;
considering a second cell as a candidate cell for cell reselection based on the WUS configuration;
transmitting, to the second cell, a WUS based on the WUS configuration for requesting a system information block 1 (SIB 1); and
receiving, from the second cell, the SIB1.

2. The method of claim 1,
wherein, in case that the second cell is an on-demand SIB1 cell, a subcarrier offset of synchronization signal block (SSB) is greater than a predetermined value, and
wherein the subcarrier offset of the SSB is obtained based on a master information block (MIB) of the second cell.

3. The method of claim 1,
wherein, in case that the cell is barred based on a master information block (MIB) of the first cell, the terminal receives an SIB1 of the first cell and another SIB including the WUS configuration from the first cell.

4. The method of claim 1,
wherein the WUS configuration includes at least one of resource information or power control information for transmitting the WUS,
wherein the terminal receives a part of information included in the SIB1 of the second cell from the first cell, and
wherein the part of the information includes information related to an access.

5. A method performed by a base station (BS) in a wireless communication system, the method comprising:
transmitting, on a second cell, a synchronization signal block (SSB);
receiving, on the second cell from a terminal that received a wake up signal (WUS) configuration from a first cell, a WUS for requesting system information block 1 (SIB 1) of the second cell; and
transmitting, on the second cell, the SIB 1 based on the WUS,
wherein, in case that the second cell is an on-demand SIB1 cell, a subcarrier offset of the SSB is greater than a predetermined value, and
wherein the subcarrier offset of the SSB is included in a master information block (MIB) of the second cell.

6. The method of claim 5,
wherein the second cell is considered as a candidate cell for cell reselection based on the WUS configuration.

7. The method of claim 5,
wherein, in case that the cell is barred based on a MIB of the first cell, the terminal receives SIB1 of the first cell and another SIB including the WUS configuration from the first cell.

8. The method of claim 5,
wherein the WUS configuration includes at least one of resource information or power control information for transmitting the WUS,
wherein the terminal receives a part of information included in the SIB1 of the second cell from the first cell, and
wherein the part of the information includes information related to an access.

9. A terminal in a wireless communication system, the terminal comprising:
a transceiver; and
at least one processor coupled to the transceiver and configured to:
receive, from a first cell, a wake up signal (WUS) configuration,
consider a second cell as a candidate cell for cell reselection based on the WUS configuration,
transmit, to the second cell, a WUS based on the WUS configuration for requesting a system information block 1 (SIB 1), and
receive, from the second cell, the SIB1.

10. The terminal of claim 9,
wherein, in case that the second cell is an on-demand SIB1 cell, a subcarrier offset of a synchronization signal block (SSB) is greater than a predetermined value, and
wherein the subcarrier offset of the SSB is obtained based on a master information block (MIB) of the second cell.

11. The terminal of claim 9,
wherein, in case that the cell is barred based on a master information block (MIB) of the first cell, the terminal receives an SIB1 of the first cell and another SIB including the WUS configuration from the first cell.

12. The terminal of claim 9,
wherein the WUS configuration includes at least one of resource information or power control information for transmitting the WUS,
wherein the terminal receives a part of information included in the SIB1 of the second cell from the first cell, and
wherein the part of the information includes information related to an access.

13. A base station (BS) in a wireless communication system, the BS comprising:
a transceiver; and
at least one processor coupled to the transceiver and configured to:
transmit, on a second cell, a synchronization signal block (SSB),
receive, on the second cell from a terminal that received a WUS configuration from a first cell, a WUS for requesting a system information block 1 (SIB 1) of the second cell, and
transmit, on the second cell, the SIB 1 based on the WUS,
wherein, in case that the second cell is an on-demand SIB1 cell, a subcarrier offset of the SSB is greater than a predetermined value, and
wherein the subcarrier offset of the SSB is included in a master information block (MIB) of the second cell.

14. The BS of claim 13,
wherein the second cell is considered as a candidate cell for cell reselection based on the WUS configuration.

15. The BS of claim 13,
wherein, in case that the cell is barred based on a MIB of the first cell, the terminal receives SIB1 of the first cell and another SIB including the WUS configuration from the first cell.

16. The BS of claim 13,
wherein the WUS configuration includes at least one of resource information or power control information for transmitting the WUS,
wherein the terminal receives a part of information included in the SIB1 of the second cell from the first cell, and
wherein the part of the information includes information related to an access.
